(19) United States
(12) Patent Application Publication
(10) Pub. No.: US 2024/0364878 A1
(43) Pub. Date: Oct. 31, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Wenbin YIN, Beijing (CN); Kai Zhang, Los Angeles, CA (US); Yue Li, Los Angeles, CA (US); Hongbin Liu, Beijing (CN); Li Zhang, Los Angeles, CA (US)

(21) Appl. No.: 18/759,646

(22) Filed: Jun. 28, 2024

Related U.S. Application Data
(63) Continuation of application No. PCT/CN2022/143499, filed on Dec. 29, 2022.

(30) Foreign Application Priority Data
Dec. 30, 2021 (WO) PCT/CN2021/143439

(51) Int. Cl. H04N 19/117; H04N 19/139; H04N 19/176; H04N 19/186; H04N 19/70; H04N 19/82

(52) U.S. Cl. CPC H04N 19/117; H04N 19/139; H04N 19/176; H04N 19/186; H04N 19/70; H04N 19/82

(57) ABSTRACT

Embodiments of the disclosure provide a solution for video processing. A method for video processing is proposed. The method includes: determining, during a conversion between a video unit of a video and a bitstream of the video unit, information of a previously coded picture associated with the video unit; during a filtering process, filtering at least one sample in a current picture associated with the video unit based on the information; and performing the conversion based on the filtered at least one sample.

### CROSS-REFERENCE TO RELATED APPLICATIONS

This application is a continuation of International Application No. PCT/CN2022/143499, filed on Dec. 29, 2022, which claims the benefit of International Application No. PCT/CN2021/143439 filed on Dec. 30, 2021. The entire contents of these applications are hereby incorporated by reference in their entireties.

### FIELD

Embodiments of the present disclosure relates generally to video coding techniques, and more particularly, to extended taps for adaptive loop filter in video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a video unit of a current picture of a video and a bitstream of the video unit, information of a previously coded picture associated with the video unit; during a filtering process, filtering at least one sample of the video unit based on the information; and performing the conversion based on the filtered at least one sample. The method in accordance with the first aspect of the present disclosure considers spatial reconstruction samples and other valuable information in the filtering process, which can advantageously improve the coding efficiency and performance.

In a second aspect, another method for video processing is proposed. The method comprises: determining, during a conversion between a video unit and a bitstream of the video unit, a relaxation of a symmetrical constrain of a parameter in a filtering process; applying the filtering process to the video unit based on the relaxation; and performing the conversion based on the filtered video unit. The method in accordance with the second aspect of the present disclosure considers the relaxation of symmetrical constrains, which can advantageously improve the coding efficiency and performance.

In a third aspect, an apparatus for processing video data is proposed. The apparatus for processing video data comprises a processor and a non-transitory memory with instructions thereon. The instructions upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, a non-transitory computer-readable recording medium is proposed. The non-transitory computer-readable recording medium stores a bitstream of a video which is generated by a method performed by a video processing apparatus. The method comprises: determining information of a previously coded picture associated with the video unit; during a filtering process, filtering at least one sample of the video unit based on the information; and generating the bitstream based on the filtered at least one sample.

In a sixth aspect, a method for storing a bitstream of a video is proposed. The method comprises: determining information of a previously coded picture associated with the video unit; during a filtering process, filtering at least one sample of the video unit based on the information; generating the bitstream based on the filtered at least one sample; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by a video processing apparatus. The method comprises: determining, during a conversion between a video unit and a bitstream of the video unit, a relaxation of a symmetrical constrain of a parameter in a filtering process; applying the filtering process to the video unit based on the relaxation; and generating the bitstream based on the filtered video unit.

In an eighth aspect, a method for storing a bitstream of a video is proposed. The method comprises: determining, during a conversion between a video unit and a bitstream of the video unit, a relaxation of a symmetrical constrain of a parameter in a filtering process; applying the filtering process to the video unit based on the relaxation; generating the bitstream based on the filtered video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 shows a nominal vertical and horizontal locations of 4:2:2 luma and chroma samples in a picture;

FIG. 5 shows an example of encoder block diagram;

FIG. 6 shows a picture with 18 by 12 luma CTUs that is partitioned into 12 tiles and 3 raster-scan slices;

FIG. 7 shows a picture with 18 by 12 luma CTUs that is partitioned into 24 tiles and 9 rectangular slices;

FIG. 8 shows a picture is partitioned into 4 tiles, 11 bricks, and 4 rectangular slices;

FIGS. 9a-9b show examples of CTBs crossing picture border where FIG. 9a shows CTBs crossing the bottom picture border, FIG. 9b shows CTBs crossing the right picture border, and FIG. 9c shows CTBs crossing the right bottom picture border;

FIG. 10 shows 67 intra prediction modes;

FIG. 11 is an illustration of picture samples and horizontal and vertical block boundaries on the 8×8 grid, and the nonoverlapping blocks of the 8×8 samples, which can be deblocked in parallel;

FIG. 12 shows pixels involved in filter on/off decision and strong/weak filter selection;

FIG. 13 shows filter shapes for ALF;

FIG. 14 shows relative coordinator for the 5×5 diamond filter support;

FIG. 15 shows examples of relative coordinates for the 5×5 diamond filter support;

FIG. 16 shows examples of a filter with both of spatial taps and extended taps;

FIG. 17 shows examples of a 5×5 diamond filter support in ALF;

FIG. 18 shows examples of a 5×5 diamond filter support in ALF with relaxation of symmetrical constrain;

FIG. 19 shows examples of a 5×5 diamond filter support in ALF with relaxation of symmetrical constrain;

FIG. 20 shows examples of a 5×5 diamond filter support in ALF with relaxation of symmetrical constrain;

FIG. 21 illustrates a flowchart of a method for video processing in accordance with some embodiments of the present disclosure;

FIG. 22 illustrates a flowchart of a method for video processing in accordance with some embodiments of the present disclosure; and

FIG. 23 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

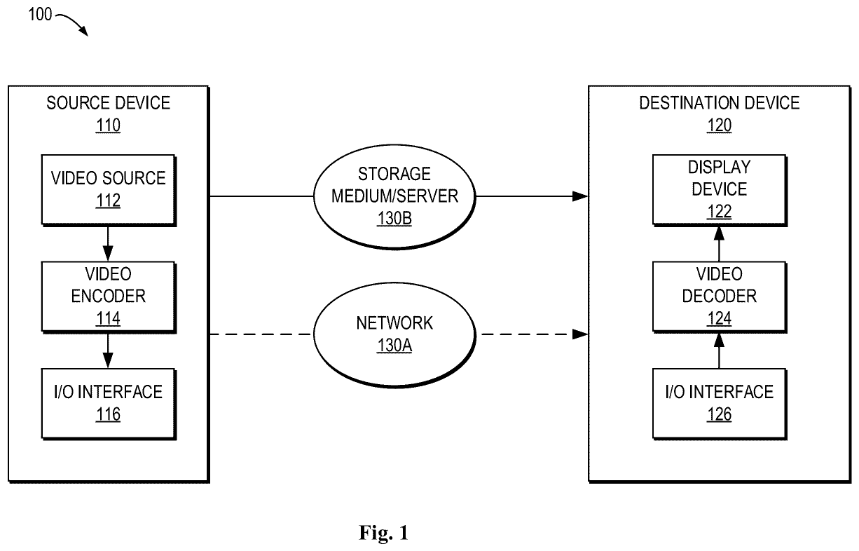

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

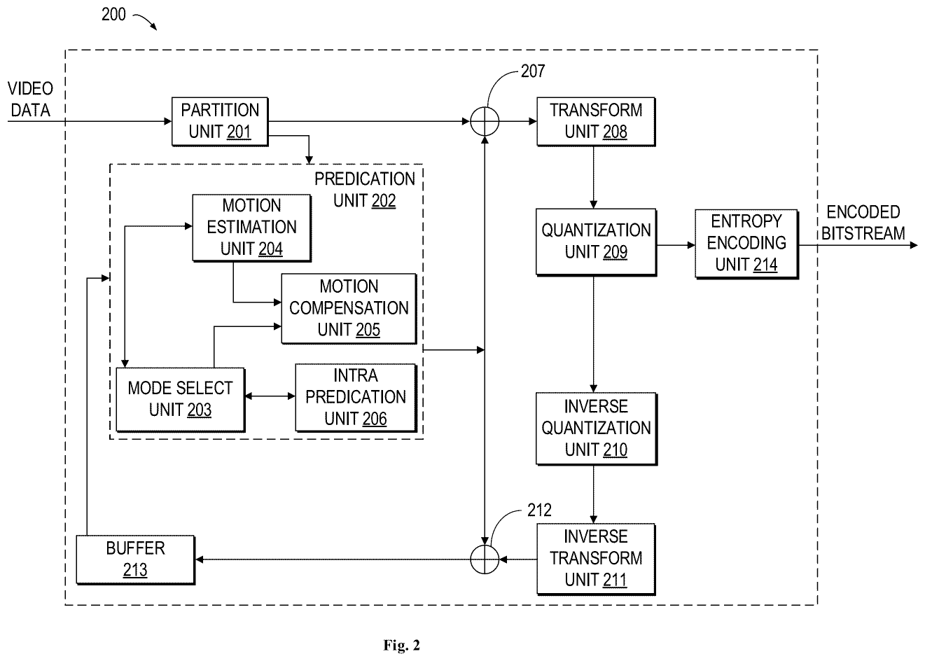

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

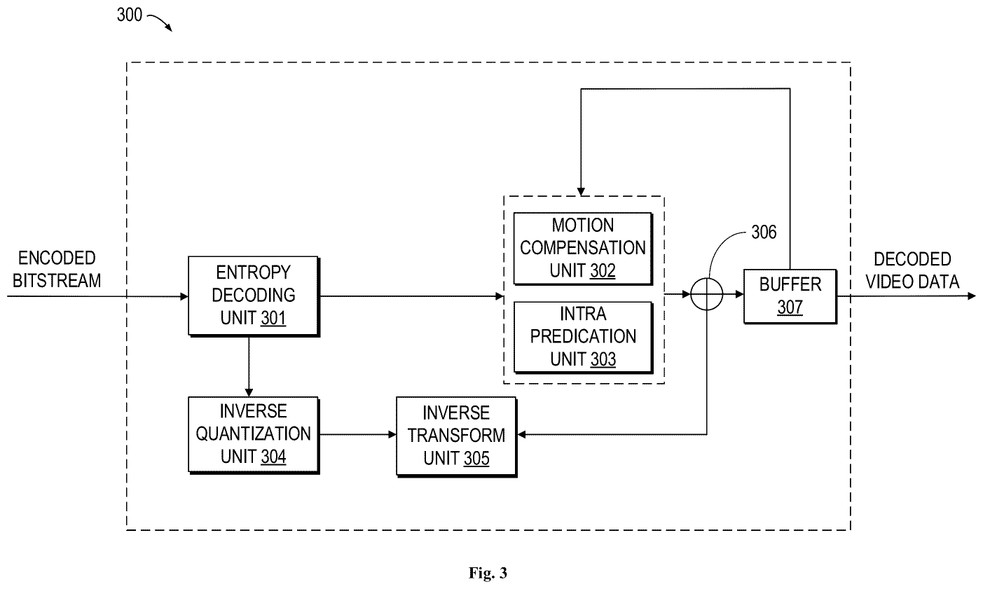

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

The present disclosure is related to video coding technologies. Specifically, it is related to in-loop filter and other coding tools in image/video coding. The ideas may be applied individually or in various combination, to any existing video coding standard or non-standard video codec like High Efficiency Video Coding (HEVC) and Versatile Video Coding (VVC). The proposed ideas may be also applicable to future video coding standards or video codec.

### 2. Abbreviations

AVC Advanced Video Coding
CPB Coded Picture Buffer
CRA Clean Random Access
CTU Coding Tree Unit
CVS Coded Video Sequence
DPB Decoded Picture Buffer
DPS Decoding Parameter Set
GCI General Constraints Information
HEVC High Efficiency Video Coding
JEM Joint Exploration Model
MCTS Motion-Constrained Tile Sets
NAL Network Abstraction Layer
OLS Output Layer Set
PH Picture Header
PPS Picture Parameter Set
PTL Profile, Tier and Level
PU Picture Unit
RRP Reference Picture Resampling
RBSP Raw Byte Sequence Payload
SEI Supplemental Enhancement Information
SH Slice Header
SPS Sequence Parameter Set
VCL Video Coding Layer
VPS Video Parameter Set
VTM VVC Test Model
VUI Video Usability Information
VVC Versatile Video Coding
TU Transform Unit
CU Coding Unit
DF Deblocking Filter
SAO Sample Adaptive Offset
ALF Adaptive Loop Filter
CBF Coding Block Flag
QP Quantization Parameter
RDO Rate Distortion Optimization
BF Bilateral Filter

### 3. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM) [2]. The JVET meeting is concurrently held once every quarter, and the new coding standard is targeting at 50% bitrate reduction as compared to HEVC. The new video coding standard was officially named as Versatile Video Coding (VVC) in the April 2018 JVET meeting, and the first version of VVC test model (VTM) was released at that time. As there are continuous effort contributing to VVC standardization, new coding techniques are being adopted to the VVC standard in every JVET meeting. The VVC working draft and test model VTM are then updated after every meeting.

The latest version of VVC draft, i.e., Versatile Video Coding (Draft 10) may be found at: https://jvet-experts.org/doc_end_user/documents/19_Teleconference/wg11/JVET-S2001-v17.zip. The latest reference software of VVC, named as VTM, could be found at: https://vcgit.hhi.fraunhofer.de/jvet-u-ee2/VVCSoftware_VTM/-/tree/VTM-11.2.

ITU-T VCEG (Q6/16) and ISO/IEC MPEG (JTC 1/SC 29/WG 11) are studying the potential need for standardization of future video coding technology with a compression capability that significantly exceeds that of the current VVC standard. Such future standardization action could either take the form of additional extension(s) of VVC or an entirely new standard. The groups are working together on this exploration activity in a joint-collaboration effort known as the Joint Video Exploration Team (JVET) to evaluate compression technology designs proposed by their experts in this area. The first Exploration Experiments (EE) were established in JVET meeting during 6-15 Jan. 2021 and the reference software named as Enhanced Compression Model (ECM). The test model ECM is updated after every JVET meeting.

### 3.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

3.1.1. 4:4:4

Each of the three Y′CbCr components have the same sample rate, thus there is no chroma subsampling. This scheme is sometimes used in high-end film scanners and cinematic postproduction.

3.1.2. 4:2:2

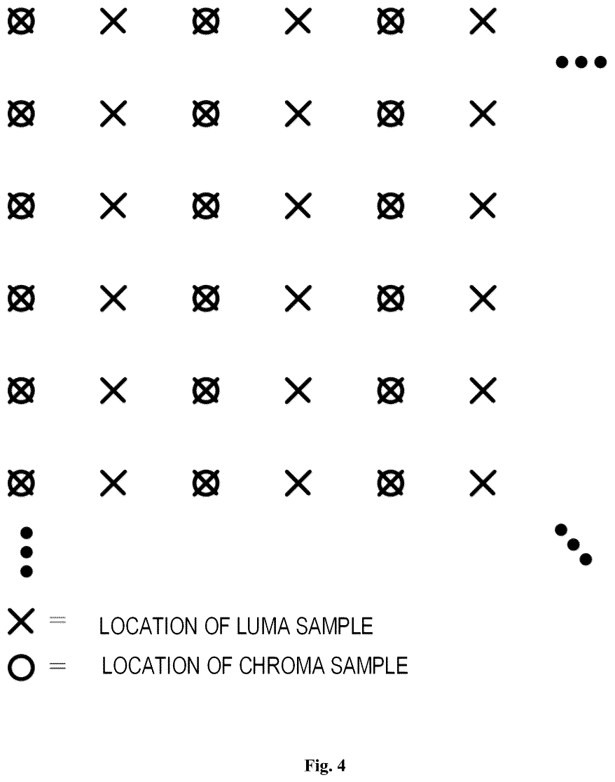

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4. FIG. 4 shows nominal vertical and horizontal locations of 4:2:2 luma and chroma samples in a picture.

3.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially),
In JPEG/JFIF, H.261, and MPEG-1. Cb and Cr are sited interstitially, halfway between alternate luma samples.
In 4:2:0 DV, Cb and Cr are co-sited in the horizontal direction. In the vertical direction, they are co-sited on alternating lines.

TABLE 1
SubWidthC and SubHeightC values derived from
chroma_format_idc and separate_colour_plane_flag

| chroma_format_idc | separate_colour_plane_flag | Chroma format | SubWidthC | SubHeightC |
|---|---|---|---|---|
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 3.2. Coding Flow of a Typical Video Codec

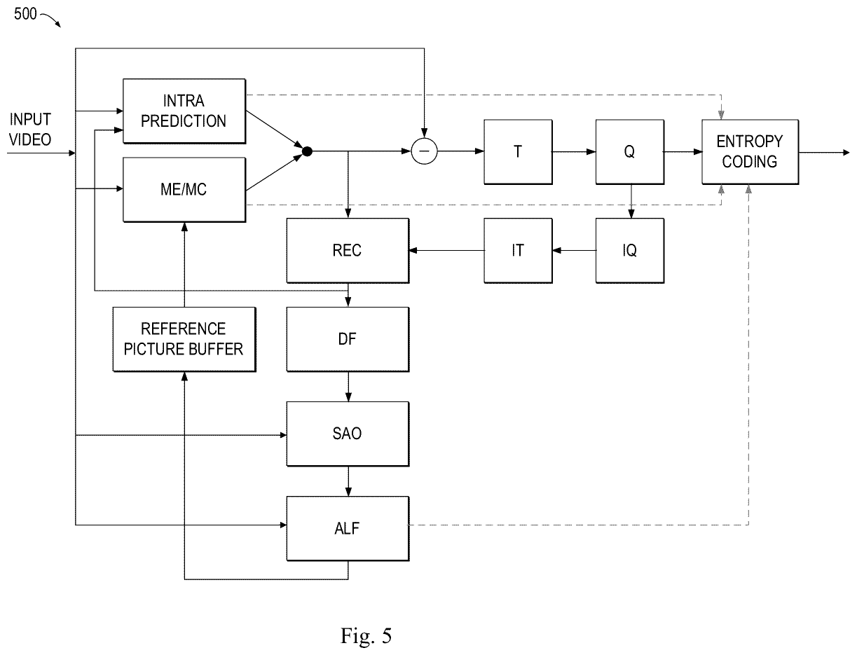

FIG. 5 shows an example of encoder block diagram 500 of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 3.3. Definitions of Video/Coding Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains several tiles of a picture or several bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

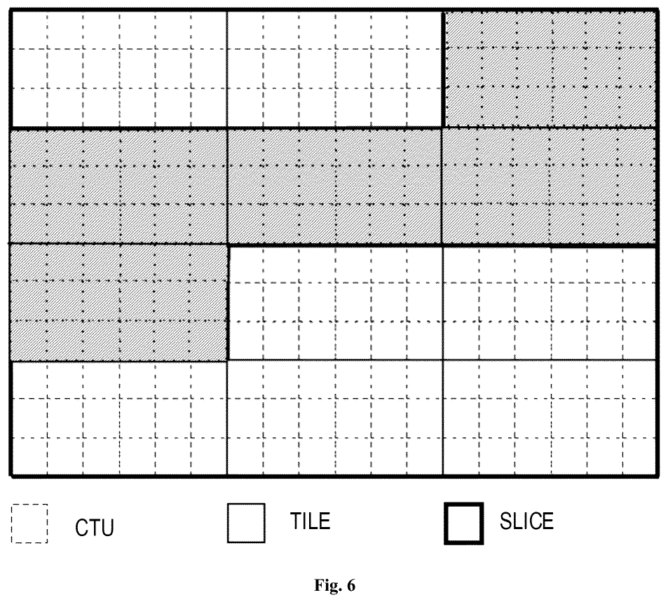

FIG. 6 shows an example of raster-scan slice partitioning of a picture, where the picture is divided into 12 tiles and 3 raster-scan slices. As shown in FIG. 6, it illustrates a picture with 18 by 12 luma CTUs that is partitioned into 12 tiles and 3 raster-scan slices.

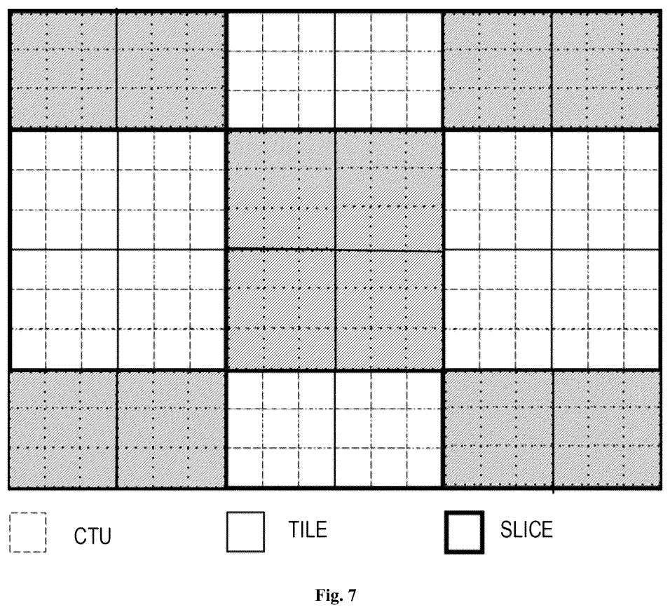

FIG. 7 in the VVC specification shows an example of rectangular slice partitioning of a picture, where the picture is divided into 24 tiles (6 tile columns and 4 tile rows) and 9 rectangular slices. As shown in FIG. 7, it illustrates a picture with 18 by 12 luma CTUs that is partitioned into 24 tiles and 9 rectangular slices.

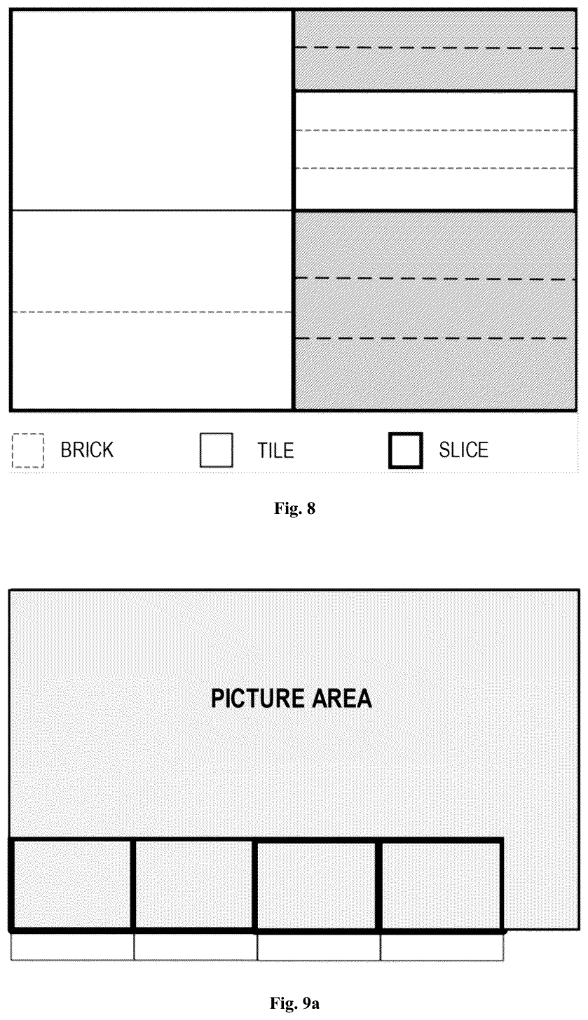

FIG. 8 in the VVC specification shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. As shown in FIG. 8, it illustrates a picture is partitioned into 4 tiles, 11 bricks, and 4 rectangular slices.

### 3.3.1. CTU/CTB Sizes

In VVC, the CTU size, signaled in SPS by the syntax element log 2_ctu_size_minus2, could be as small as 4×4.

### 7.3.2.3 Sequence Parameter Set RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rp10_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.

log 2_min_luma_coding_block_size_minus2 plus 2 specifies the minimum luma coding block size. The variables CtbLog 2SizeY, CtbSizeY, MinCbLog 2SizeY, MinCbSizeY, MinTbLog 2SizeY, MaxTbLog 2SizeY, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

| | |
|---|---|
| CtbLog2SizeY = log2_ctu_size_minus2 + 2 | (7-9) |
| CtbSizeY = 1 << CtbLog2SizeY | (7-10) |
| MinCbLog2SizeY = log2_min_luma_coding_block_size_minus2 + 2 | (7-11) |
| MinCbSizeY = 1 << MinCbLog2SizeY | |
| | (7-12) |
| MinTbLog2SizeY = 2 | (7-13) |
| MaxTbLog2SizeY = 6 | (7-14) |
| MinTbSizeY = 1 << MinTbLog2SizeY | |
| | (7-15) |
| MaxTbSizeY = 1 << MaxTbLog2SizeY | |
| | (7-16) |
| PicWidthInCtbsY = Ceil( pic_width_in_luma_samples ÷ CtbSizeY ) | (7-17) |
| PicHeightInCtbsY = Ceil( pic_height_in_luma_samples ÷ CtbSizeY ) | (7-18) |
| PicSizeInCtbsY = PicWidthInCtbsY * PicHeightInCtbsY | (7-19) |
| PicWidthInMinCbsY = pic_width_in_luma_samples / MinCbSizeY | (7-20) |
| PicHeightInMinCbsY = pic_height_in_luma_samples / MinCbSizeY | (7-21) |
| PicSizeInMinCbsY = PicWidthInMinCbsY * PicHeightInMinCbsY | (7-22) |

PicSizeInSamplesY = pic_width_in_luma_samples * pic_height_in_luma_samples (7-23)

| | |
|---|---|
| PicWidthInSamplesC = pic_width_in_luma_samples / SubWidthC | (7-24) |
| PicHeightInSamplesC = pic_height_in_luma_samples / SubHeightC | (7-25). |

### 3.3.2. CTUs in One Picture

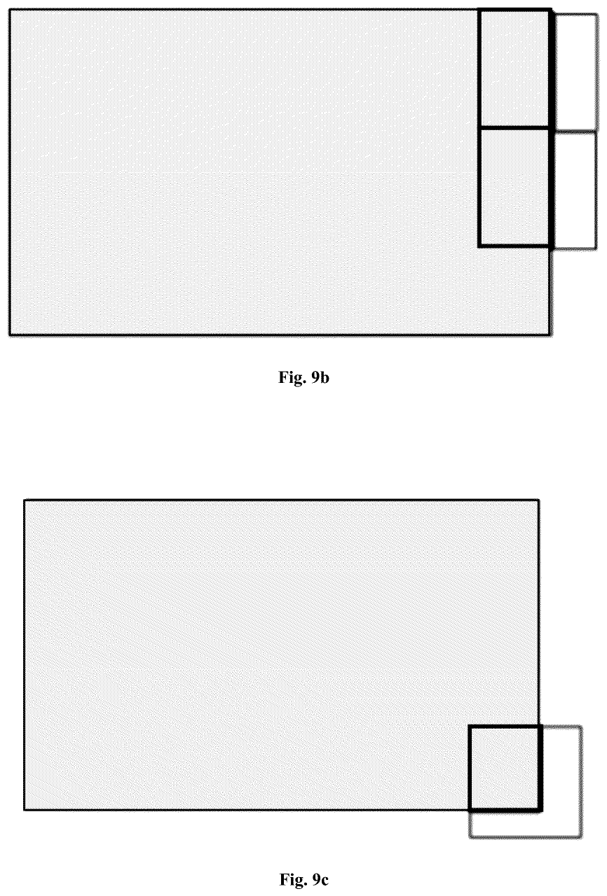

Suppose the CTB/LCU size indicated by M x N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIGS. 9a-9c, the CTB size is still equal to M×N, however, the bottom boundary/right boundary of the CTB is outside the picture. FIGS. 9a-9b show examples of CTBs crossing picture border. FIG. 9a shows CTBs crossing the bottom picture border, FIG. 9b shows CTBs crossing the right picture border, and FIG. 9c shows CTBs crossing the right bottom picture border.

### 3.4. Intra Prediction

To capture the arbitrary edge directions presented in natural video, the number of directional intra modes is extended from 33, as used in HEVC, to 65. The additional directional modes are depicted, and the planar and DC modes remain the same. These denser directional intra prediction modes apply for all block sizes and for both luma and chroma intra predictions.

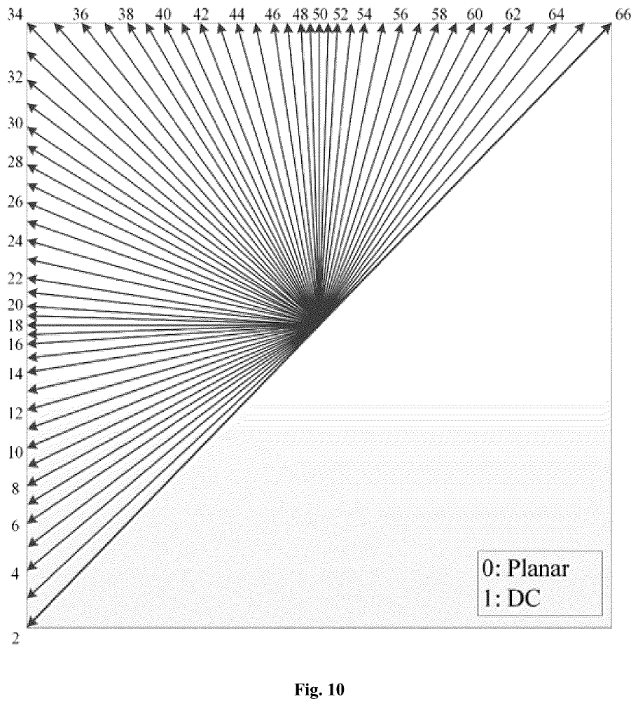

FIG. 10 shows 67 intra prediction modes. Conventional angular intra prediction directions are defined from 45 degrees to −135 degrees in clockwise direction as shown in FIG. 10. In VTM, several conventional angular intra prediction modes are adaptively replaced with wide-angle intra prediction modes for the non-square blocks. The replaced modes are signalled using the original method and remapped to the indexes of wide angular modes after parsing. The total number of intra prediction modes is unchanged, i.e., 67, and the intra mode coding is unchanged.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 3.5. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 3.6. Deblocking Filter

Deblocking filtering typical in-loop filter in video codec. In VVC, the deblocking filtering process is applied on CU boundaries, transform subblock boundaries and prediction subblock boundaries. The prediction subblock boundaries include the prediction unit boundaries introduced by the SbTMVP (Subblock based Temporal Motion Vector prediction) and affine modes, and the transform subblock boundaries include the transform unit boundaries introduced by SBT (Subblock transform) and ISP (Intra Sub-Partitions) modes and transforms due to implicit split of large CUs. As done in HEVC, the processing order of the deblocking filter is defined as horizontal filtering for vertical edges for the entire picture first, followed by vertical filtering for horizontal edges. This specific order enables either multiple horizontal filtering or vertical filtering processes to be applied in parallel threads or can still be implemented on a CTB-by-CTB basis with only a small processing latency.

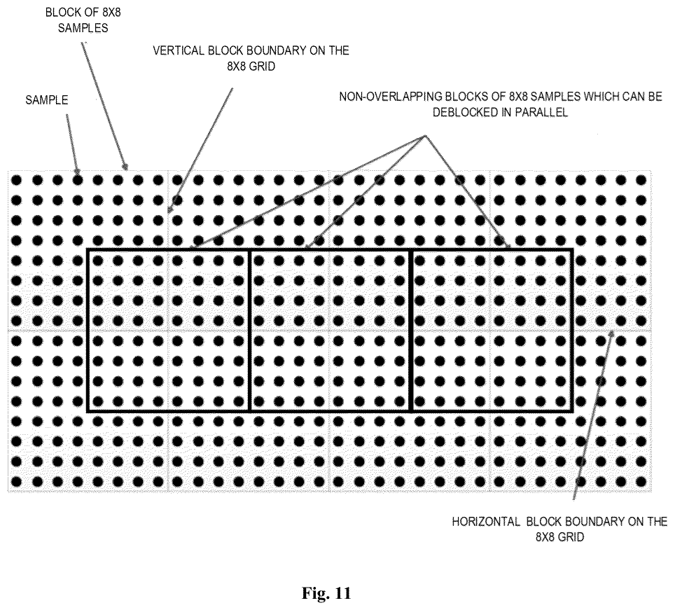

FIG. 11 is illustration of picture samples and horizontal and vertical block boundaries on the 8×8 grid, and the nonoverlapping blocks of the 8×8 samples, which can be deblocked in parallel.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

### 3.6.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 3.6.2. Boundary Strength Calculation

For a transform block boundary/coding subblock boundary, if it is located in the 8×8 grid, it may be filtered and the setting of bS[xDᵢ][yDⱼ] (wherein [xDᵢ][yDⱼ] denotes the coordinate) for this edge is defined in Table 1 and Table 2, respectively.

TABLE 3-2
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent | 1 | 1 | 1 |
| | blocks has non-zero transform coefficients | | | |
| 3 | Reference pictures or number of MVs (1 for | 1 | N/A | N/A |
| | uni-prediction, 2 for bi-prediction) of the | | | |
| | adjacent blocks are different | | | |
| 2 | Absolute difference between the motion | 1 | N/A | N/A |
| | vectors of same reference picture that belong | | | |
| | to the adjacent blocks is greater than or | | | |
| | equal to one integer luma sample | | | |
| 1 | Otherwise | 0 | 0 | 0 |

TABLE 3-3
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent | 1 | 1 | 1 |
| | blocks has non-zero transform coefficients | | | |
| 6 | Prediction mode of adjacent blocks is | 1 | | |
| | different (e.g., one is IBC, one is inter) | | | |
| 5 | Both IBC and absolute difference between | 1 | N/A | N/A |
| | the motion vectors that belong to the | | | |
| | adjacent blocks is greater than or equal | | | |
| | to one integer luma sample | | | |
| 4 | Reference pictures or number of MVs (1 for | 1 | N/A | N/A |
| | uni-prediction, 2 for bi-prediction) of the | | | |
| | adjacent blocks are different | | | |
| 3 | Absolute difference between the motion | 1 | N/A | N/A |
| | vectors of same reference picture that | | | |
| | belong to the adjacent blocks is greater | | | |
| | than or equal to one integer luma sample | | | |
| 1 | Otherwise | 0 | 0 | 0 |

### 3.6.3. Deblocking Decision for Luma Component

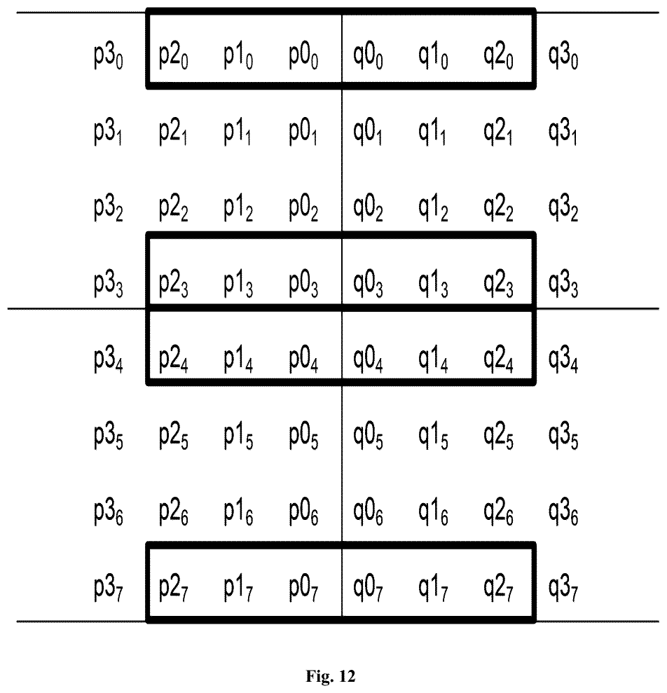

FIG. 12 shows pixels involved in filter on/off decision and strong/weak filter selection.

Wider-stronger luma filter is filters are used only if all the Condition1, Condition2 and Condition 3 are TRUE.

The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.
bSidePisLargeBlk=((edge type is vertical and p₀ belongs to CU with width>=32) (edge type is horizontal and p₀ belongs to CU with height>=32))? TRUE: FALSE
bSideQisLargeBlk=((edge type is vertical and q₀ belongs to CU with width>=32)|(edge type is horizontal and q₀ belongs to CU with height>=32))? TRUE: FALSE.

Based on bSidePisLargeBlk and bSideQisLargeBlk, the condition 1 is defined as follows.

Condition1=(bSidePisLargeBlk∥ bSidePisLargeBlk)? TRUE: FALSE

Next, if Condition 1 is true, the condition 2 will be further checked. First, the following variables are derived:

| | |
|---|---|
| - | dp0, dp3, dq0, dq3 are first derived as in HEVC |
| - | if (p side is greater than or equal to 32) |
| | dp0 = ( dp0 + Abs( p5₀ − 2 * p4₀ + p3₀ ) + 1 ) >> 1 |
| | dp3 = ( dp3 + Abs( p5₃ − 2 * p4₃ + p3₃ ) + 1 ) >> 1 |
| - | if (q side is greater than or equal to 32) |
| | dq0 = ( dq0 + Abs( q5₀ − 2 * q4₀ + q3₀ ) + 1 ) >> 1 |
| | dq3 = ( dq3 + Abs( q5₃ − 2 * q4₃ + q3₃ ) + 1 ) >> 1 |

Condition2 = (d < β) ? TRUE: FALSE

where d= dp0 + dq0 + dp3 + dq3.

If Condition1 and Condition2 are valid, whether any of the blocks uses sub-blocks is further checked:

```
If (bSidePisLargeBlk)
  {
      If (mode block P == SUBBLOCKMODE)
          Sp =5
        else
          Sp =7
}
else
  Sp = 3
If (bSideQisLargeBlk)
    {
      If (mode block Q == SUBBLOCKMODE)
          Sq =5
        else
          Sq =7
      }
else
  Sq = 3.
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
dpq is derived as in HEVC.
sp₃ = Abs( p₃ − p₀ ), derived as in HEVC
if (p side is greater than or equal to 32)
    if(Sp==5)
      sp₃ = ( sp₃ + Abs( p₅ − p₃ ) + 1) >> 1
    else
      sp₃ = ( sp₃ + Abs( p₇ − p₃ ) + 1) >> 1
sq₃ = Abs( q₀ − q₃ ), derived as in HEVC
if (q side is greater than or equal to 32)
  If(Sq==5)
    sq₃ = ( sq₃ + Abs( q₅ − q₃ ) +1) >> 1
  else
    sq₃ = ( sq₃ + Abs( q₇ − q₃ ) +1) >> 1.
```

As in HEVC, StrongFilterCondition=(dpq is less than (β>>2), sp₃+sq₃ is less than (3*β>>5), and Abs(p₀−q₀) is less than (5*t_{c}+1)>>1)? TRUE:FALSE.

### 3.6.4. Stronger Deblocking Filter for Luma

Bilinear filter is used when samples at either one side of a boundary belong to a large block. A sample belonging to a large block is defined as when the width>=32 for a vertical edge, and when height>=32 for a horizontal edge.

The bilinear filter is listed below.

Block boundary samples pᵢ for i=0 to Sp−1 and qᵢ for j=0 to Sq−1 (pᵢ and qᵢ are the i-th sample within a row for filtering vertical edge, or the i-th sample within a column for filtering horizontal edge) in HEVC deblocking described above) are then replaced by linear interpolation as follows:

$${{p}_{i}}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i}$$

$${{q}_{j}}^{′} = ( {g}_{j} * {Middle}_{s , t} + ( 64 - {g}_{j} ) * {Q}_{s} + 32 ) ≫ 6 ) , clipped to {q}_{j} \pm {tcPD}_{j}$$

where tcPDᵢ and tcPDⱼ term is a position dependent clipping described in Section 3.6.2 and gⱼ, fᵢ, Middle_{s,t}, Pₛ and Qₛ are given below.

### 3.6.5. Deblocking Decision for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.

The second condition will be TRUE when d is less than β.

In the third condition StrongFilterCondition is derived as follows:
dpq is derived as in HEVC.
sp₃=Abs(p₃−p₀), derived as in HEVC
sq₃=Abs(q₀−q₃), derived as in HEVC.

As in HEVC design, StrongFilterCondition=(dpq is less than ((β>>2), sp₃+sq₃ is less than (β>>3), andAbs(p0−g0) is less than (5*t_{C}+1)>>1).

### 3.6.6. Strong Deblocking Filter for Chroma

The following strong deblocking filter for chroma is defined:

$${{p}_{2}}^{′} = ( 3 * {p}_{3} + 2 * {p}_{2} + {p}_{1} + {p}_{0} + {q}_{0} + 4 ) ≫ 3$$

$${{p}_{1}}^{′} = ( 2 * {p}_{3} + {p}_{2} + 2 * {p}_{1} + {p}_{0} + {q}_{0} + {q}_{1} + 4 ) ≫ 3$$

$${{p}_{0}}^{′} = ( {p}_{3} + {p}_{2} + {p}_{1} + 2 * {p}_{0} + {q}_{0} + {q}_{1} + {q}_{2} + 4 ) ≫ 3.$$

The proposed chroma filter performs deblocking on a 4×4 chroma sample grid.

### 3.6.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

$$Tc 7 = \{ 6 , 5 , 4 , 3 , 2 , 1 , 1 \} ; Tc 3 = \{ 6 , 4 , 2 \} ;$$

$$tcPD = ( Sp == 3 ) ? Tc 3 : Tc 7 ;$$

$$tcQD = ( Sq == 3 ) ? Tc 3 : Tc 7.$$

For the P or Q boundaries being filtered with a short symmetrical filter, position dependent threshold of lower magnitude is applied:
Tc3={3, 2, 1}.

Following defining the threshold, filtered p′ᵢ and q′ᵢ sample values are clipped according to tcP and tcQ clipping values:

$${{{{p ”}_{i} = Clip 3 ( p ’}_{i} + {tcP}_{i} , p ’}_{i} - {tcP}_{i} , p ’}_{i} ) ,$$

$${{{{q ”}_{j} = Clip 3 ( q ’}_{j} + {tcQ}_{j} , q ’}_{j} - {tcQ}_{j} , q ’}_{j} ) ,$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 3.6.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 ∥ edge == (orthogonalLength − 2) ∥ edge == (56 / 4) ∥
    edge == (72 / 4))
        Sp = Sq = 2;
      else
        Sp = Sq = 3;
  else
      Sp = Sq = bSideQisLargeBlk ? 5:3
}.
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 3.7. Sample Adaptive Offset

Sample adaptive offset (SAO) is applied to the reconstructed signal after the deblocking filter by using offsets specified for each CTB by the encoder. The video encoder first makes the decision on whether or not the SAO process is to be applied for current slice. If SAO is applied for the slice, each CTB is classified as one of five SAO types as shown in Table. 3-1. The concept of SAO is to classify pixels into categories and reduces the distortion by adding an offset to pixels of each category. SAO operation includes edge offset (EO) which uses edge properties for pixel classification in SAO type 1 to 4 and band offset (BO) which uses pixel intensity for pixel classification in SAO type 5. Each applicable CTB has SAO parameters including sao_merge_left_flag, sao_merge_up_flag, SAO type and four offsets. If sao_merge_left_flag is equal to 1, the current CTB will reuse the SAO type and offsets of the CTB to the left. If sao_merge_up_flag is equal to 1, the current CTB will reuse SAO type and offsets of the CTB above.

TABLE 3-4
Specification of SAO type

| | sample adaptive offset | Number of |
|---|---|---|
| SAO type | type to be used | categories |
| 0 | None | 0 |
| 1 | 1-D 0-degree pattern edge offset | 4 |
| 2 | 1-D 90-degree pattern edge offset | 4 |
| 3 | 1-D 135-degree pattern edge | 4 |
| | offset | |
| 4 | 1-D 45-degree pattern edge offset | 4 |
| 5 | band offset | 4 |

### 3.8. Adaptive Loop Filter

Adaptive loop filtering for video coding is to minimize the mean square error between original samples and decoded samples by using Wiener-based adaptive filter. The ALF is located at the last processing stage for each picture and can be regarded as a tool to catch and fix artifacts from previous stages. The suitable filter coefficients are determined by the encoder and explicitly signalled to the decoder. To achieve better coding efficiency, especially for high resolution videos, local adaptation is used for luma signals by applying different filters to different regions or blocks in a picture. In addition to filter adaptation, filter on/off control at coding tree unit (CTU) level is also helpful for improving coding efficiency. Syntax-wise, filter coefficients are sent in a picture level header called adaptation parameter set, and filter on/off flags of CTUs are interleaved at CTU level in the slice data. This syntax design not only supports picture level optimization but also achieves a low encoding latency.

### 3.8.1. Signaling of Parameters

According to ALF design in VTM, filter coefficients and clipping indices are carried in ALF APSs. An ALF APS can include up to 8 chroma filters and one luma filter set with up to 25 filters. An index is also included for each of the 25 luma classes. Classes having the same index share the same filter. By merging different classes, the num of bits required to represent the filter coefficients is reduced. The absolute value of a filter coefficient is represented using a 0^{th} order Exp-Golomb code followed by a sign bit for a non-zero coefficient. When clipping is enabled, a clipping index is also signalled for each filter coefficient using a two-bit fixed-length code. Up to 8 ALF APSs can be used by the decoder at the same time.

Filter control syntax elements of ALF in VTM include two types of information. First, ALF on/off flags are signalled at sequence, picture, slice and CTB levels. Chroma ALF can be enabled at picture and slice level only if luma ALF is enabled at the corresponding level. Second, filter usage information is signalled at picture, slice and CTB level, if ALF is enabled at that level. Referenced ALF APSs IDs are coded at a slice level or at a picture level if all the slices within the picture use the same APSs. Luma component can reference up to 7 ALF APSs and chroma components can reference 1 ALF APS. For a luma CTB, an index is signalled indicating which ALF APS or offline trained luma filter set is used. For a chroma CTB, the index indicates which filter in the referenced APS is used.

The data syntax elements of ALF associated to LUMA component in VTM are listed as follows:

| | Descriptor |
|---|---|
| alf_data( ) { | |
| alf_luma_filter_signal_flag | u(1) |
| if( alf_luma_filter_signal_flag ) { | |
| alf_luma_clip_flag | u(1) |
| alf_luma_num_filters_signalled_minus1 | ue(v) |
| if( alf_luma_num_filters_signalled_minus1 > 0 ) | |
| for( filtIdx = 0; filtIdx < NumAlfFilters; filtIdx++ ) | |
| alf_luma_coeff_delta_idx[ filtIdx ] | u(v) |
| for( sfIdx = 0; sfIdx <= alf_luma_num_filters_signalled_minus1; sfIdx++ | |
| ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfldx <= alf_luma_num_filters_signalled_minus1; | |
| sfIdx++ ) | |
| for( j = 0; j < 12; j++ ) | |
| alf_luma_clip_idx[ sfIdx ][ j ] | u(2) |
| } | |

alf_luma_filter_signal_flag equal to 1 specifies that a luma filter set is signalled. alf_luma_filter_signal_flag equal to 0 specifies that a luma filter set is not signalled. alf_luma_clip_flag equal to 0 specifies that linear adaptive loop filtering is applied to the luma component. alf_luma_clip_flag equal to 1 specifies that non-linear adaptive loop filtering could be applied to the luma component.

alf_luma_num_filters_signalled_minus1 plus 1 specifies the number of adaptive loop filter classes for which luma coefficients can be signalled. The value of alf_luma_num_filters_signalled_minus1 shall be in the range of 0 to NumAlfFilters−1, inclusive.

alf_luma_coeff_delta_idx[filtIdx] specifies the indices of the signalled adaptive loop filter luma coefficient deltas for the filter class indicated by filtIdx ranging from 0 to NumAlfFilters−1. When alf_luma_coeff_delta_idx[filtIdx] is not present, it is inferred to be equal to 0. The length of alf_luma_coeff_delta_idx[filtIdx] is Ceil(Log 2(alf_luma_num_filters_signalled_minus1+1)) bits. The value of alf_luma_coeff_delta_idx[filtIdx] shall be in the range of 0 to alf_luma_num_filters_signalled_minus1, inclusive.

alf_luma_coeff_abs[sfIdx][j] specifies the absolute value of the j-th coefficient of the signalled luma filter indicated by sfIdx. When alf_luma_coeff_abs [sfIdx][j] is not present, it is inferred to be equal 0. The value of alf_luma_coeff_abs[sfIdx][j] shall be in the range of 0 to 128, inclusive.

alf_luma_coeff_sign[sfIdx][j] specifies the sign of the j-th luma coefficient of the filter indicated by sfIdx as follows:
If alf_luma_coeff_sign[sfIdx][j] is equal to 0, the corresponding luma filter coefficient has a positive value.
Otherwise (alf_luma_coeff_sign[sfIdx][j] is equal to 1), the corresponding luma filter coefficient has a negative value.

When alf_luma_coeff_sign[sfIdx][j] is not present, it is inferred to be equal to 0.

alf_luma_clip_idx[sfIdx][j] specifies the clipping index of the clipping value to use before multiplying by the j-th coefficient of the signalled luma filter indicated by sfIdx. When alf_luma_clip_dx[sfIdx][j] is not present, it is inferred to be equal to 0.

The coding tree unit syntax elements of ALF associated to LUMA component in VTM are listed as follows:

| | Descriptor |
|---|---|
| coding_tree_unit( ) { | |
| xCtb = CtbAddrX << CtbLog2Size Y | |
| yCtb = CtbAddrY << CtbLog2Size Y | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma_prev_filter_idx | ae(v) |
| } else | |
| alf_luma_fixed_filter_idx | ae(v) |
| } | |
| } | |

alf_ctb_flag[cIdx][xCtb>>CtbLog 2SizeY][yCtb>>CtbLog 2SizeY] equal to 1 specifies that the adaptive loop filter is applied to the coding tree block of the colour component indicated by cIdx of the coding tree unit at luma location (xCtb, yCtb).

alf_ctb_flag[cIdx][xCtb>>CtbLog 2SizeY][yCtb>>CtbLog 2SizeY] equal to 0 specifies that the adaptive loop filter is not applied to the coding tree block of the colour component indicated by cIdx of the coding tree unit at luma location (xCtb, yCtb).

When alf_ctb_flag[cIdx][xCtb>>CtbLog 2SizeY][yCtb>>CtbLog 2SizeY] is not present, it is inferred to be equal to 0.

alf_use_aps_flag equal to 0 specifies that one of the fixed filter sets is applied to the luma CTB. alf_use_aps_flag equal to 1 specifies that a filter set from an APS is applied to the luma CTB. When alf_use_aps_flag is not present, it is inferred to be equal to 0.

alf_luma_prev_filter_idx specifies the previous filter that is applied to the luma CTB. The value of alf_luma_prev_filter_idx shall be in a range of 0 to sh_num_alf_aps_ids_luma−1, inclusive. When alf_luma_prev_filter_idx is not present, it is inferred to be equal to 0.

The variable AlfCtbFiltSetIdxY[xCtb>>CtbLog 2SizeY][yCtb>>CtbLog 2SizeY] specifying the filter set index for the luma CTB at location (xCtb, yCtb) is derived as follows:
If alf_use_aps_flag is equal to 0, AlfCtbFiltSetIdxY[xCtb>>CtbLog 2SizeY][yCtb>>CtbLog 2SizeY] is set equal to alf_luma_fixed_filter_idx.
Otherwise, AlfCtbFiltSetIdxY[xCtb>>CtbLog 2SizeY][yCtb>>CtbLog 2SizeY] is set equal to 16+alf_luma_prev_filter_idx.

alf_luma_fixed_filter_idx specifies the fixed filter that is applied to the luma CTB. The value of alf_luma_fixed_filter_idx shall be in a range of 0 to 15, inclusive.

Based on the ALF design of VTM, the ALF design of ECM further introduces the concept of alternative filter sets into luma filters. The luma filters are be trained multiple alternatives/rounds based on the updated luma CTU ALF on/off decisions of each alternative/rounds. In such way, there will be multiple filter sets that associated to each training alternative and the class merging results of each filter set may be different. Each CTU could select the best filter set by RDO and the related alternative information will be signaled. The data syntax elements of ALF associated to LUMA component in ECM are listed as follows:

| | Descriptor |
|---|---|
| alf_data( ) { | |
| alf_luma_filter_signal_flag | u(1) |
| if( alf_luma_filter_signal_flag ) { | |
| alf_luma_num_alts_minus1 | ue(v) |
| for(altIdx = 0; altIdx < alf_luma_num_alts_minus1 +1; altIdx++){ | |
| alf_luma_clip_flag[altIdx] | u(1) |
| alf_luma_num_filters_signalled_minus1[altIdx] | ue(v) |
| if(alf_luma_num_filters_signalled_minus1[altIdx] > 0){ | |
| for( filtIdx = 0; filtIdx < NumAlfFilters; filtIdx++ ) | |
| alf_luma_coeff_delta_idx[altIdx][filtIdx] | u(v) |
| } | |
| for(sfIdx = 0; sfIdx <= alf_luma_num_filters_signalled_minus1[altIdx]; | |
| sfIdx++){ | |
| for(j = 0; j < 19; j++){ | |
| alf_luma_coeff_abs[altIdx][ sfIdx ][ j ] | ue(v) |
| if( alf_luma_coeff_abs[altIdx][ sfIdx ][ j ] ) | |
| alf_luma_coeff_sign[altIdx][ sfIdx ][ j ] | u(1) |
| } | |
| } | |
| if( alf_luma_clip_flag [altIdx]) | |
| for( sfIdx = 0; sfIdx <= | |
| alf_luma_num_filters_signalled_minus1[altIdx]; sfIdx++ ) | |
| for( j = 0; j <19; j++ ) | |
| alf_luma_clip_idx[altIdx][ sfIdx ][ j ] | u(2) |
| } | |
| } | |

alf_luma_num_alts_minus1 plus 1 specifies the number of alternative filter sets for luma component. The value of alf_luma_num_alts_minus1 shall be in the range of 0 to 3, inclusive.

alf_luma_clip_flag[altIdx] equal to 0 specifies that linear adaptive loop filtering is applied to the alternative luma filter set with index altIdx. alf_luma_clip_flag[altIdx] equal to 1 specifies that non-linear adaptive loop filtering could be applied to the alternative luma filter set with index altIdx.

alf_luma_num_filters_signalled_minus1[altIdx] plus 1 specifies the number of adaptive loop filter classes for which luma coefficients can be signalled of the alternative luma filter set with index altIdx. The value of alf_luma_num_filters_signalled_minus1 [altIdx] shall be in the range of 0 to NumAlfFilters−1, inclusive.

alf_luma_coeff_delta_idx[altIdx][filtIdx] specifies the indices of the signalled adaptive loop filter luma coefficient deltas for the filter class indicated by filtIdx ranging from 0 to NumAlfFilters−1 for the alternative luma filter set with index altIdx. When alf_luma_coeff_delta_idx[filtIdx][altIdx] is not present, it is inferred to be equal to 0. The length of alf_luma_coeff_delta_idx[altIdx][filtIdx] is Ceil(Log 2(alf_luma_num_filters_signalled_minus1[altIdx]+1)) bits. The value of alf_luma_coeff_delta_idx[altIdx][filtIdx] shall be in the range of 0 to alf_luma_num_filters_signalled_minus1 [altIdx], inclusive.

alf_luma_coeff_abs[altIdx][sfIdx][j] specifies the absolute value of the j-th coefficient of the signalled luma filter indicated by sfIdx of the alternative luma filter set with index altIdx. When alf_luma_coeff_abs[altIdx][sfIdx][j] is not present, it is inferred to be equal 0. The value of alf_luma_coeff_abs[altIdx][sfIdx][j] shall be in the range of 0 to 128, inclusive.

alf_luma_coeff_sign[altIdx][sfIdx][j] specifies the sign of the j-th luma coefficient of the filter indicated by sfIdx of the alternative luma filter set with index altIdx as follows:
If alf_luma_coeff_sign[altIdx][sfIdx][j] is equal to 0, the corresponding luma filter coefficient has a positive value.
Otherwise (alf_luma_coeff_sign[altIdx][sfIdx][j] is equal to 1), the corresponding luma filter coefficient has a negative value.

When alf_luma_coeff_sign[altIdx][sfIdx][j] is not present, it is inferred to be equal to 0.

alf_luma_clip_idx[altIdx][sfIdx][j] specifies the clipping index of the clipping value to use before multiplying by the j-th coefficient of the signalled luma filter indicated by sfIdx of the alternative luma filter set with index altIdx. When alf_luma_clip_idx[altIdx][sfIdx][j] is not present, it is inferred to be equal to 0.

The coding tree unit syntax elements of ALF associated to LUMA component in ECM are listed as follows:

| | Descriptor |
|---|---|
| coding_tree_unit( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alt_ctb_luma_filter_alt_idx[CtbAddrX][CtbAddrY] | ae(v) |
| alf_luma_prev_filter_idx | ae(v) |
| } else | |
| alf_luma_fixed_filter_idx | ae(v) |
| } | |
| } | |

alf_ctb_luma_filter_alt_idx[xCtb>>CtbLog 2SizeY][yCtb>>CtbLog 2SizeY] specifies the index of the alternative luma filters applied to the coding tree block of the luma component, of the coding tree unit at luma location (xCtb, yCtb). When alf_ctb_luma_filter_alt_idx[xCtb>>CtbLog 2SizeY][yCtb>>CtbLog 2SizeY] is not present, it is inferred to be equal to zero.

### 3.8.2. Filter Shapes

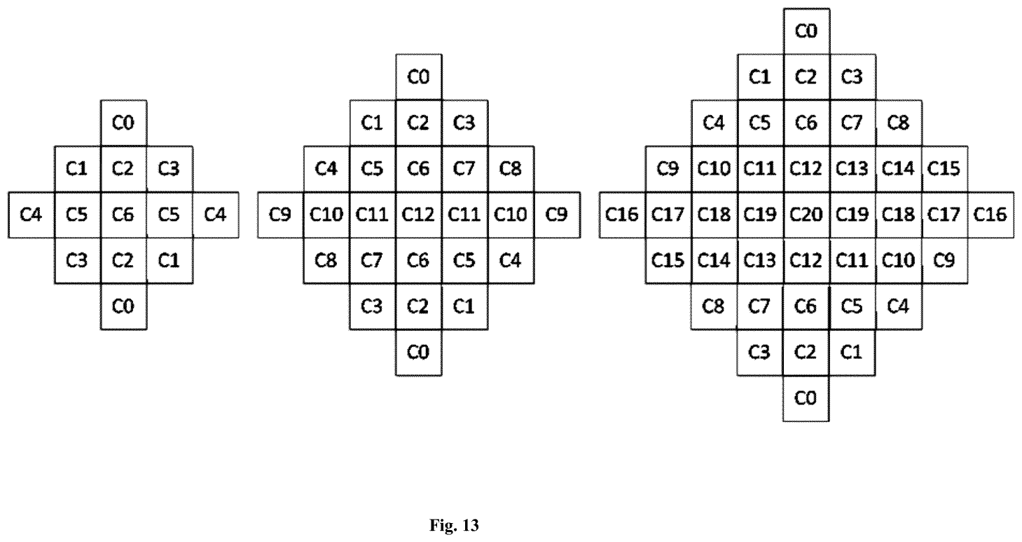

In the JEM, up to three diamond filter shapes (as shown in FIG. 13) can be selected for the luma component. FIG. 13 shows filter shapes for ALF. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used. In VVC, the 7×7 diamond shape is always used for Luma while the 5×5 diamond shape is always used for Chroma.

### 3.8.3. Classification for ALF

Each 2×2 (or 4×4) block is categorized into one out of 25 classes. The classification index C is derived based on its directionality D and a quantized value of activity A, as follows:

$$C = 5 D + \hat{A} .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

Indices i and j refer to the coordinates of the upper left sample in the 2×2 block and R(i,j) indicates a reconstructed sample at coordinate (i,j).

Then D maximum and minimum values of the gradients of horizontal and vertical directions are set as:

g_{h,v}^{max}=max(gₕ,gᵥ),g_{h,v}^{min}=min(gₕ,gᵥ),

and the maximum and minimum values of the gradient of two diagonal directions are set as:

g_{d0,d1}^{max}=max(g_{d0},g_{d1}),g_{d0,d1}^{min}=min(g_{d0},g_{d1}),

To derive the value of the directionality D, these values are compared against each other and with two thresholds t₁ and t₂:
Step 1. If both g_{h,v}^{max}≤t₁·g_{h,v}^{min} and g_{d0,d1}^{max}≤t₁·g_{d0,d1}^{min} are true, D is set to 0.
Step 2. If g_{h,v}^{max}/g_{h,v}^{min}>g_{d0,d1}^{max}/g_{d0,d1}^{min}, continue from Step 3; otherwise continue from Step 4.
Step 3. If g_{h,v}^{max}>t₂·gₕ n, D is set to 2; otherwise D is set to 1.
Step 4. If g_{d0,d1}^{max}>t₂·g_{d0,d1}^{min}, D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as A.

For both chroma components in a picture, no classification method is applied, i.e. a single set of ALF coefficients is applied for each chroma component.

### 3.8.4. Geometric Transformations of Filter Coefficients

Before filtering each 2×2 block, geometric transformations such as rotation or diagonal and vertical flipping are applied to the filter coefficients f(k, l), which is associated with the coordinate (k, l), depending on gradient values calculated for that block. This is equivalent to applying these transformations to the samples in the filter support region. The idea is to make different blocks to which ALF is applied more similar by aligning their directionality.

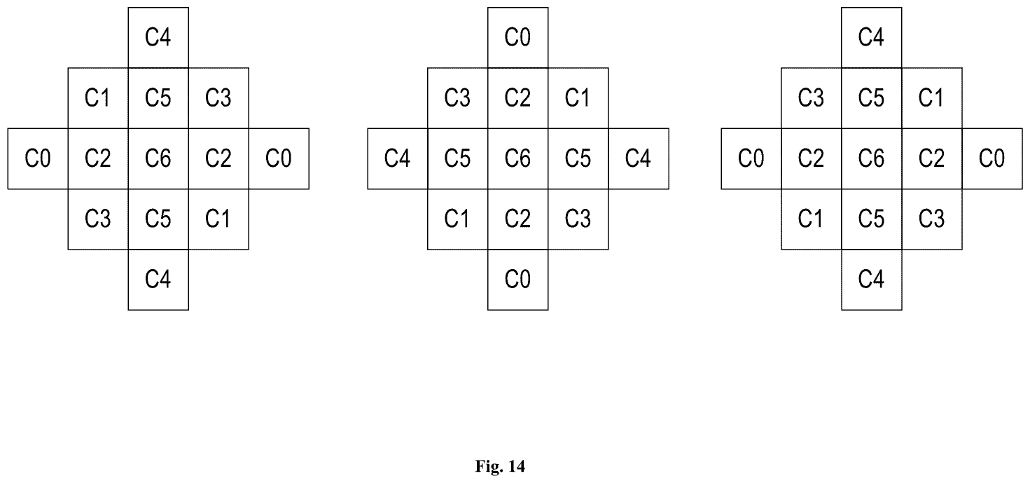

Three geometric transformations, including diagonal, vertical flip and rotation are introduced:

$$Diagonal : {f}_{D} ( k , l ) = f ( l , k ) ,$$

$$Vertical flip : {f}_{V} ( k , l ) = f ( k , K - l - 1 ) ,$$

$$Rotation : {f}_{R} ( k , l ) = f ( K - l - 1 , k ) .$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k, l) depending on gradient values calculated for that block. The relationship between the transformation and the four gradients of the four directions are summarized in Table 3-5. FIG. 14 shows the transformed coefficients for each position based on the 5×5 diamond.

TABLE 3-5
Mapping of the gradient calculated for
one block and the transformations.

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 3.8.5. Filtering Process

At decoder side, when ALF is enabled for a block, each sample R(i,j) within the block is filtered, resulting in sample value R′(i,j) as shown below, where L denotes filter length, f_{m,n} represents filter coefficient, and f(k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l )$$

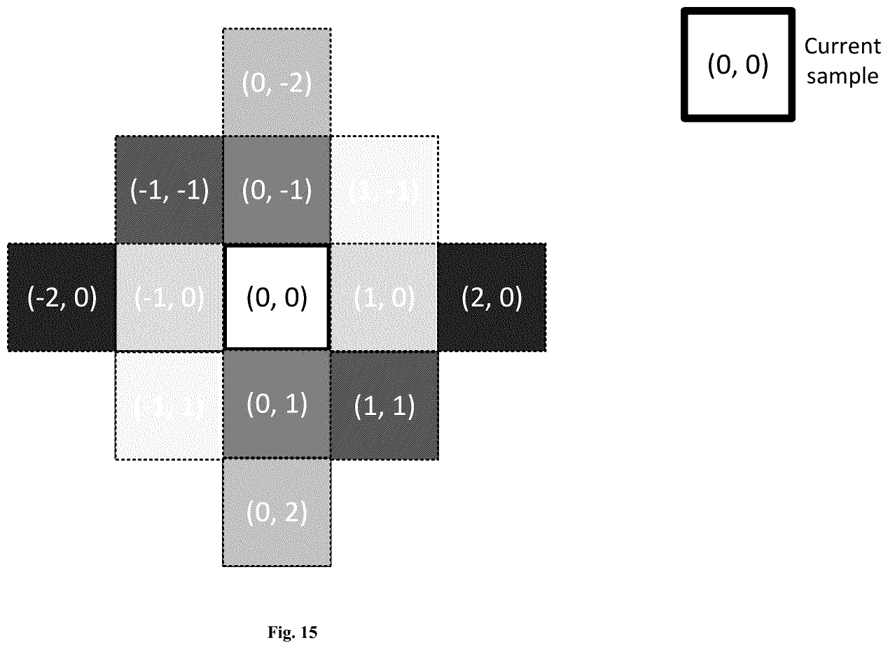

FIG. 15 shows an example of relative coordinates used for 5×5 diamond filter support supposing the current sample's coordinate (i, j) to be (0, 0). Samples in different coordinates filled with the same color are multiplied with the same filter coefficients.

### 3.8.6. Non-Linear Filtering Reformulation

Linear filtering can be reformulated, without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) )$$

where w(i,j) are the same filter coefficients.

VVC introduces the non-linearity to make ALF more efficient by using a simple clipping function to reduce the impact of neighbor sample values (I(x+i, y+j)) when they are too different with the current sample value (I(x, y)) being filtered.

More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) )$$

where K(d, b)=min(b, max(−b, d)) is the clipping function, and k(i,j) are clipping parameters, which depends on the (i,j) filter coefficient. The encoder performs the optimization to find the best k(i,j).

The clipping parameters k(i,j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The 4 values have been selected by roughly equally splitting, in the logarithmic domain, the full range of the sample values (coded on 10 bits) for Luma, and the range from 4 to 1024 for Chroma. More precisely, the Luma table of clipping values have been obtained by the following formula:

$${AlfClip}_{L} = \{ round ( {( {( M )}^{\frac{1}{N}} )}^{N - n + 1} ) for n ∈ 1 .. N ] \} , with M = {2}^{10} and N = 4$$

Similarly, the Chroma tables of clipping values is obtained according to the following formula:

$${AlfClip}_{C} = \{ round ( A \cdot {( {( \frac{M}{A} )}^{\frac{1}{N - 1}} )}^{N - n} ) for n ∈ 1 .. N ] \} , with M = {2}^{10} , N = 4 and A = 4$$

### 3.9. Bilateral In-Loop Filter

### 3.9.1. Bilateral Image Filter

Bilateral image filter is a nonlinear filter that smooths the noise while preserving edge structures. The bilateral filtering is a technique to make the filter weights decrease not only with the distance between the samples but also with increasing difference in intensity. This way, over-smoothing of edges can be ameliorated. A weight is defined as

$$w ( Δ x , Δ y , Δ I ) = {e}^{- \frac{Δ {x}^{2} + Δ {y}^{2}}{2 {σ}_{d}^{2}} - \frac{Δ {I}^{2}}{2 {σ}_{r}^{2}}}$$

where Δx and Δy is the distance in the vertical and horizontal and ΔI is the difference in intensity between the samples.

The edge-preserving de-noising bilateral filter adopts a low-pass Gaussian filter for both the domain filter and the range filter. The domain low-pass Gaussian filter gives higher weight to pixels that are spatially close to the center pixel. The range low-pass Gaussian filter gives higher weight to pixels that are similar to the center pixel. Combining the range filter and the domain filter, a bilateral filter at an edge pixel becomes an elongated Gaussian filter that is oriented along the edge and is greatly reduced in gradient direction. This is the reason why the bilateral filter can smooth the noise while preserving edge structures.

### 3.9.2. Bilateral Filter in Video Coding

The bilateral filter in video coding is proposed as a coding tool for the VVC [1]. The filter acts as a loop filter in parallel with the sample adaptive offset (SAO) filter. Both the bilateral filter and SAO act on the same input samples, each filter produces an offset, and these offsets are then added to the input sample to produce an output sample that, after clipping, goes to the next stage. The spatial filtering strength σ_{d} is determined by the block size, with smaller blocks filtered more strongly, and the intensity filtering strength σᵣ is determined by the quantization parameter, with stronger filtering being used for higher QPs. Only the four closest samples are used, so the filtered sample intensity I_{F} can be calculated as

$${I}_{F} = {I}_{C} + \frac{{w}_{A} Δ {I}_{A} + {w}_{B} Δ {I}_{B} + {w}_{L} Δ {I}_{L} + {w}_{R} Δ {I}_{R}}{{w}_{C} + {w}_{A} + {w}_{B} + {w}_{L} + {w}_{R}}$$

where I_{C} denotes the intensity of the center sample, ΔI_{A}=I_{A}−I_{C} the intensity difference between the center sample and the sample above. ΔI_{B}, ΔI_{L} and ΔI_{R} denote the intensity difference between the center sample and that of the sample below, to the left and to the right respectively.

### 4. Problems

The existing designs for adaptive loop filter in video coding have the following problems:
1. In current ALF design, only the spatial reconstruction samples are used for filter training and filtering. However, there are other valuable information that can be potentially utilized, such as samples inside reconstructed reference frames or the corresponding prediction frame.
2. In current ALF design, only Luma reconstruction samples are used for Luma filter training and filtering. However, the cross-component based concept can potentially benefit the Luma filter of ALF.
3. In current ALF design, the filter coefficients are forcefully designed in a symmetrical way. However, the relaxation of the symmetrical constrain can potentially provide more information for ALF.

### 5. Embodiments

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

It should be noted that the proposed methods may be used as in-loop filters or post-processing.

In this disclosure, a video unit may refer to a sequence, a picture, a sub-picture, a slice, a CTU, a block or a region. The video unit may comprise one color component or it may comprise multiple color components.

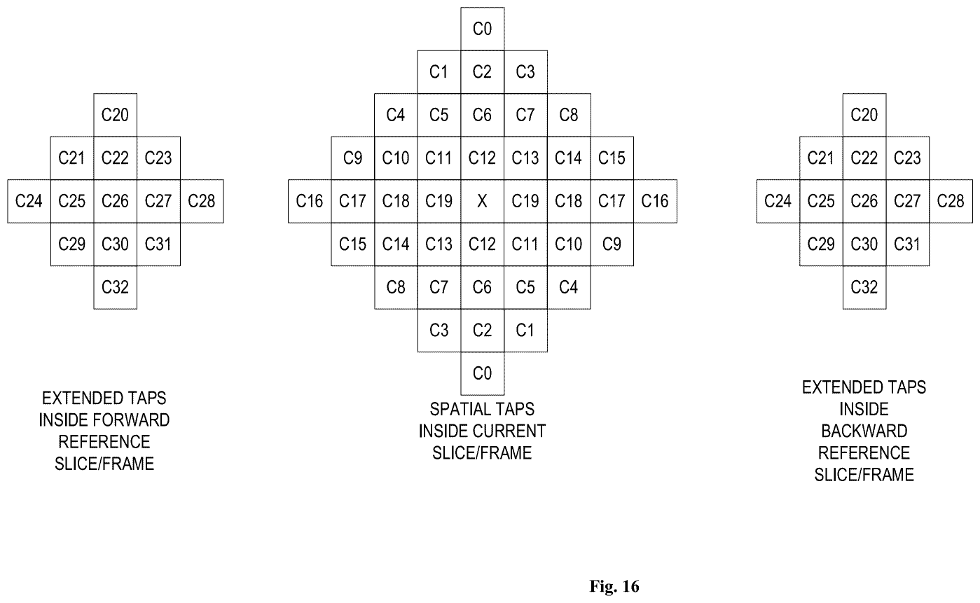

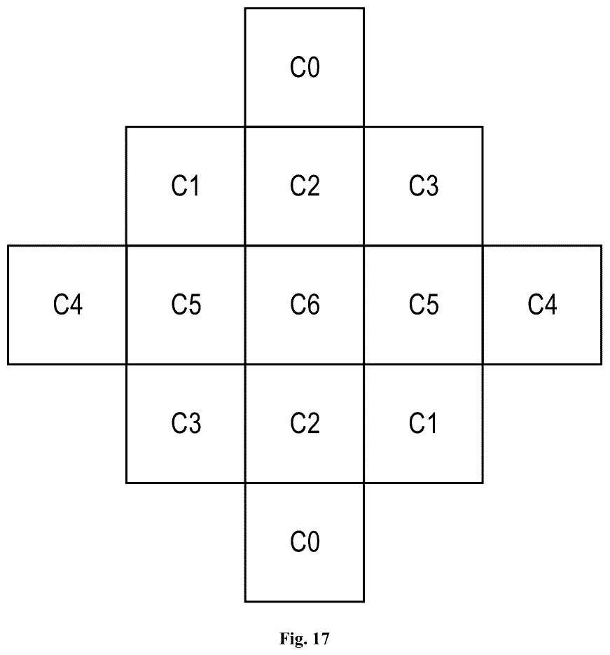

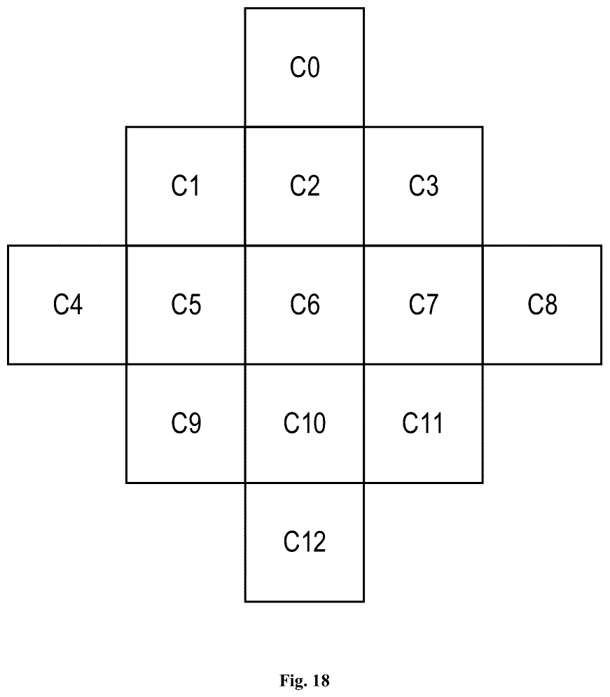

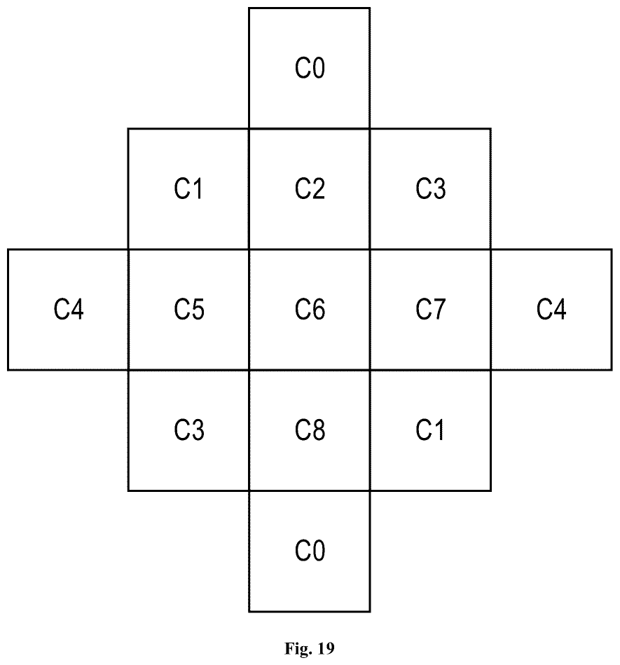

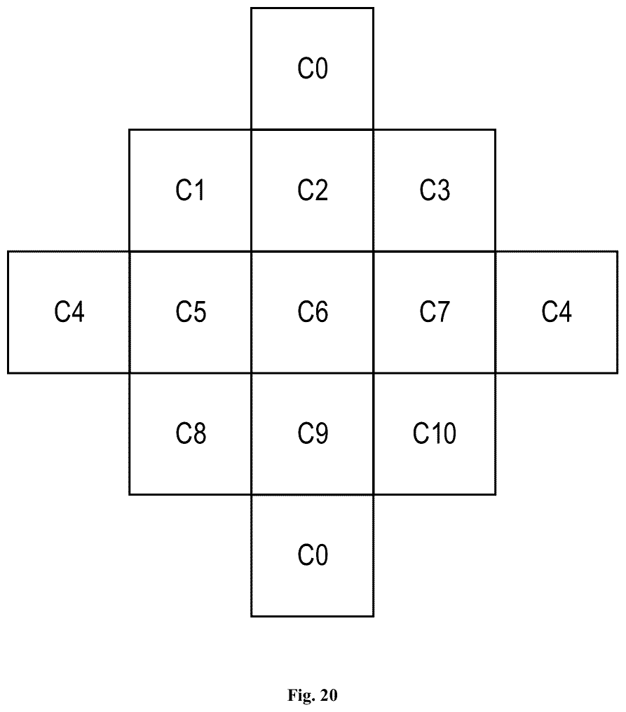

In this disclosure, an ALF processing unit may refer to a sequence, a picture, a sub-picture, a slice, a CTU, a block, a region, or a sample. The ALF processing unit may comprise one color component or it may comprise multiple color components.
1) It is proposed information (such as reconstructed samples and/or motion information) in at least one previously coded frame may be used to filter at least one sample in the current frame, in at least one filtering process, such as ALF.
   a. For example, it is proposed to use several extended taps for ALF based on one/more previously coded frames.
   b. In one example, a previously coded frame may be a reference frame in a reference picture list (RPL) or reference picture set (RPS) associated with the block/the current slice/frame.
      a) In one example, the previously coded frame may be a short-term reference picture of the block/the current slice/frame.
      b) In one example, the previously coded frame may be long-term reference picture of the block/the current slice/frame.
   c. Alternatively, the previously coded frame may NOT be a reference frame, but it is stored in the decoded picture buffer (DPB).
   d. In one example, at least one indicator is signalled to indicate which previously coded frame(s) to use.
      a) In one example, one indicator is signalled to indicate which reference picture list to use.
      b) In one example, at least one indicator may be signalled to indicate a reference index.
      c) Alternatively, the indicator may be conditionally signalled, e.g., depending on how many reference pictures are included in the RPL/RPS.
      d) Alternatively, the indicator may be conditionally signalled, e.g., depending on how many previously decoded pictures are included in the DPB.
   e. In one example, which frames to be utilized is determined on-the-fly.
      a) In one example, the extended taps may take information from one/multiple previously coded frames in DPB.
      b) In one example, the extended taps may take information from one/multiple reference frames in list 0.
      c) In one example, the extended taps may take information from one/multiple reference frames in list 1.
      d) In one example, the extended taps may take information from reference frames in both list 0 and list 1.
      e) In one example, the extended taps may take information from the reference frame closest (e.g., with smallest POC distance to current slice/frame) to the current frame.
      f) In one example, the extended taps may take information from the reference frame with reference index equal to K (e.g., K=0) in a reference list.
         1. In one example, K may be pre-defined.
         2. In one example, K may be derived on-the-fly according to reference picture information.
         3. In one example, K may be signalled.
      g) In one example, the extended taps may take information from the collocated frame.
      h) In one example, which frame to be utilized may be determined by the decoded information.
         1. In one example, which frame to be utilized may be defined as the top N (e.g., N=1) most-frequently used reference pictures for samples within the current slice/frame.
         2. In one example, which frame to be utilized may be defined as the top N (e.g., N=1) most-frequently used reference pictures of each reference picture list, if available, for samples within the current slice/frame.
         3. In one example, which frame to be utilized may be defined as the pictures with top N (e.g., N=1) smallest POC distances/absolute POC distances relative to current picture.
   f. In one example, whether to take information from previously coded frames may be dependent on decoded information (e.g., coding modes/statistics/characteristics) of at least one region of the to-be-filtered block.
      a) Alternatively, it may be signaled from an encoder to a decoder whether to take information from previously coded frames of at least one region of the to-be-filtered block.
      b) In one example, whether to take information from previously coded frames may be dependent on the slice/picture type.
         1. In one example, it may be only applicable to inter-coded slices/pictures (e.g., P or B slices/pictures).
         2. In one example, whether to take information from previously coded frames may be dependent on availability of reference pictures.
      c) In one example, whether to take information from previously coded frames may be dependent on the reference picture information or the picture information in the DPB.
         1. In one example, if the smallest POC distance (e.g., smallest POC distance between reference pictures/pictures in DPB and current picture) is greater than a threshold, it is disabled.
      d) In one example, whether to take information from previously coded frames may be dependent on the temporal layer index and/or QP and/or dimensions of the picture.
         1. In one example, it may be applicable to blocks with a given temporal layer index (e.g., the highest temporal layer).
      e) In one example, if the to-be-filtered block contains a portion of samples that are coded in non-inter mode, the extended taps may not use information from previously coded frames to filter the block.
   1. In one example, the non-inter mode may be defined as intra mode.
   2. In one example, the non-inter mode may be defined as a set of coding mode which includes but not limited of intra/IBC/Palette modes.
      f) In one example, a distortion between current block and the matching block is calculated and used to decide whether to take information from previously coded frames to filter current block.
         1. Alternatively, the distortion between the collocated block in a previously coded frame and current block may be used to decide whether to take information from previously coded frames to filter current block.
         2. In one example, motion estimation may be first used to find a matching block from at least one previously coded frame.
         3. In one example, when the distortion is larger than a pre-defined threshold, information from previously coded frames may not be used.
   g. In one example, the extended taps may take the motion information of current block and reconstructed samples in previously coded frames/slices to build/generate reference a block.
      a. In one example, reference block may be defined as those in the one/multiple reference blocks and/or collocated blocks of current block.
      b. In one example, reference block may be defined as those in a region pointed by at least one motion vector.
         i. In one example, the motion vector may be different from the decoded motion vector associated with current block.
      c. In one example, a reference block may refer to a block whose center is located at the same horizontal and vertical position in a previously coded frame as that of current block in the current frame.
      d. In one example, a reference block is derived by motion estimation, i.e. searching from a previously coded frame to find the block that is closest to current block with a certain measure.
         i. In one example, the motion estimation may be performed at integer precision to avoid fractional pixel interpolation.
         ii. Alternatively, the motion estimation may be performed at fractional precision to improve the quality of reference block.
      e. In one example, a reference block may be derived by reusing at least one motion vector contained in the current block.
         i. In one example, the motion vector may be first rounded to the integer precision to avoid fractional pixel interpolation.
         ii. In one example, the reference block may be located by adding an offset which is determined by the motion vector to the position of the current block.
         iii. In one example, the motion vector may refer to the previously coded picture containing the reference block.
         iv. In one example, the motion vector may be scaled to the previously coded picture containing the reference block.
      f. In one example, reference blocks and/or collocated blocks may be the same size of current block.
      g. In one example, reference blocks and/or collocated blocks may be larger than current block.
         i. In one example, reference blocks and/or collocated blocks with the same size of current block may be first found and then extended at each boundary to contain more samples from previously coded samples.
         1) In one example, the size of extended area may be signalled to the decoder or derived on-the-fly.
      h. In one example, the information contains two reference blocks and/or collocated blocks of current block, with one of them from the first reference frame in list-0 and the other from the first reference frame in list-1.
2) It is proposed to use several extended taps for ALF based on the cross-component concept.
   a. In one example, the extended taps may take the information of Chroma components in current frame/slice to filter Luma samples,
      a) In one example, the extended taps may only take the information of Cb or Cr component from the source frame/slice.
      b) Alternatively, the extended taps may take the information of both Chroma components from the source frame/slice.
   b. In one example, the extended taps may take the information of Chroma components in previously coded frames/slices to filter Luma samples,
      a) In one example, the extended taps may only take the information of Cb or Cr component from the source frame/slice.
      b) Alternatively, the extended taps may take the information of both Chroma component from the source frame/slice.
      c) Alternatively, which previously coded frame/slice to be used may be determined on the fly/signalled/derived or follow the way mentioned in previous claims.
      d) Alternatively, whether to use previously coded frame/slice may be determined on the fly/signalled/derived or follow the way mentioned in previous claims.
   c. In one example, the extended taps may take the information of Luma component in current frame/slice to filter Chroma samples,
      a) In one example, the extended taps may be only applied to filter Cb or Cr component.
      b) Alternatively, the extended taps may be applied to filter both of Chroma components.
   d. In one example, the extended taps may take the information of Luma component in previously coded frames/slices to filter Chroma samples,
      a) In one example, the extended taps may be only applied to filter Cb or Cr component.
      b) Alternatively, the extended taps may be applied to filter both of Chroma component.
      c) In one example, which previously coded frame/slice to be used may be determined on the fly/signalled/derived or follow the way mentioned in previous claims.
      d) In one example, whether to use previously coded frame/slice may be determined on the fly/signalled/derived or follow the way mentioned in previous claims.
   e. In one example, the extended taps may take the information of a first chroma component in current frame/slice to filter Chroma samples of a second chroma component.
   f. In one example, the extended taps may take the information of a first chroma component in previously coded frames/slices to filter Chroma samples of a second chroma component.
      a) In one example, which previously coded frame/slice to be used may be determined on the fly/signalled/derived or follow the way mentioned in previous claims.
      b) In one example, whether to use previously coded frame/slice may be determined on the fly/signalled/derived or follow the way mentioned in previous claims.
3) It is proposed to use several extended taps for ALF to further enhance the efficiency of ALF.
   a. In one example, the extended taps may be different from the spatial taps in ALF which only utilize the information of the spatial neighbour samples of the filtering component (e.g. only use spatial neighbour luma samples to filter the central luma sample inside one filter shape).
   b. In one example, the extended taps may be applied to different color components.
      a) In one example, the extended taps may be applied to both of Luma and Chroma components.
      b) In one example, the extended taps may be only applied to Luma component.
      c) Alternatively, the extended taps may be only applied to Chroma component.
   c. In one example, Ŝ(x,y)=F({S_{i,j}(x,y)}, {E_{m,n}(x, y)}), wherein Ŝ(x,y) is a sample at (x, y) after filtering, {S_{i,j}(x, y)} is a set of samples corresponding to spatial taps, {E_{m,n}(x, y)} is a set of samples corresponding to extended taps and F is a joint filtering function.
      a) Alternatively, Ŝ(x,y)=G(F({S_{i,j}(x,y)}), {E_{m,n}(x, y)}), F is a first stage filtering function applied on spatial taps only and G is a second stage filtering function.
      b) Alternatively, Ŝ(x,y)=G({S_{i,j}(x,y)},F({E_{m,n}(x,y)})), F is a first stage filtering function applied on extended taps only and G is a second stage filtering function.
      c) Alternatively, S(x,y)=K(F({S_{i,j}(x,y)}), G({E_{m,n}(x,y)}), F is a first filtering function applied on spatial taps only and G is a second filtering function applied on extended taps only and K is a joint filtering function.
   d. In one example, the extended taps may be used as the additional taps of a filter shape in ALF.
      a) In one example, the extended taps may be combined with the spatial taps to form one filter.
      b) In one example, the training data collection for extended and spatial taps may be performed jointly.
      c) Alternatively, the coefficients of extended and spatial taps may be trained jointly.
      d) Alternatively, the clipping parameters of extended and spatial taps may be generated jointly.
      e) In one example, other parameters of extended and spatial taps may be derived jointly.
   e. Alternatively, the extended taps may be used as an independent filter in ALF.
      a) In one example, the extended taps may be performed as an independent filter.
      b) In one example, the training data collection for extended taps may be performed individually.
         1. In one example, the training data collection for extended taps may be performed based on ALF-unfiltered samples.
         2. Alternatively, the training data collection for extended taps may be performed based on the ALF-filtered samples.
      c) Alternatively, the coefficients of extended taps may be trained individually.
      d) Alternatively, the clipping parameters of extended taps may be generated/derived individually.
      e) In one example, other parameters of extended taps may be derived independently.
f. In one example, the extended taps may use different shapes or sizes.
   a) In one example, the spatial taps and extended taps of one filter may distribute as shown in FIG. 16. FIG. 16 shows examples of a filter with both spatial taps and extended taps. The spatial taps may use a diamond shape with size of 9 while the extended taps may use a diamond shape with size of 5. The extended taps may be used in both of forward and backward reference slice/frame.
   b) In one example, the extended taps may use different shapes.
      1. In one example, the extended taps may use a diamond shape.
      2. In one example, the extended taps may use a square shape.
      3. In one example, the extended taps may use a cross shape.
      4. Alternatively, the extended taps may use a symmetrical shape.
      5. Alternatively, the extended taps may use an asymmetrical shape.
      6. Alternatively, the extended taps may use any other shapes.
      7. In one example, the shape of extended taps may be determined on the fly/signalled/derived.
   c) In one example, the extended taps may use different sizes.
      1. In one example, the extended taps may use filter length equal to N (e.g. N=3).
      2. In one example, the filter length of extended taps may be determined on the fly/signalled/derived.
   d) In one example, the symmetrical constrain may be performed on extended taps.
      1. In one example, the geometric symmetrical constrain may be performed on extended taps.
      2. Alternatively, the temporal symmetrical constrain may be performed on extended taps when more than 1 reference blocks are used.
      3. In one example, the geometric and temporal symmetrical constrain may be performed individually.
      4. Alternatively, the geometric and temporal symmetrical constrain may be performed jointly.
   e) In one example, the total number of extended taps may be derived based on the shape, filter length, symmetrical constrain jointly.
   f) The center of the filtering shape of the extended taps may be at the same position of the current sample to be filtered, but maybe in different frames.
   g) The center (at position A) of the filtering shape of the extended taps may be at a different position of the current sample (at position A) to be filtered, and maybe in different frames.
      1. In one example, the displacement between position A and B may be determined by a motion vector.
         a. The motion vector may be rounded to integer samples.
         b. The motion vector may be scaled to the required reference frame.
         c. In one example, the motion vector may be derived by the MV of a block covering the current sample. The block may be a PU/CU/CTU/etc.
         a) In one example, if there is no MV of the block covering the current sample (such as intra-coded), a default one may be used, such as (0,0).
         b) In one example, if there is no MV of the block covering the current sample, a replacement MV may be used. The replacement MV may be derived from a neighbouring block with a MV.
         c) In one example, if there is multiple MVs of the block covering the current sample, one of them may be used. For example, the one at the center of the block may be used.
   g. In one example, the classification for extended taps may be performed.
      a) In one example, the classification for extended taps may be performed based on texture information.
      b) In one example, the classification for extended taps may be performed based on band information.
      c) Alternatively, the classification for spatial taps may be reused for extended taps. d) In one example, the class merging for extended taps may be performed independently.
      e) Alternatively, the class merging for spatial taps may be reused for extended taps.
   h. In one example, a first syntax element may be signaled to indicate whether extended taps are enabled.
      a) In one example, the first syntax element may be coded by arithmetic coding
         1. In one example, the first syntax element may be coded with at least one context.
         a. The context may depend on coding information of the current block or neighbouring block.
         b. The context may depend on the filtering shape of at least one neighbouring block.
         2. In one example, the first syntax element may be coded with bypass coding.
      b) In one example, the first syntax element may be binarized by unary code, or truncated unary code, or fixed-length code, or exponential Golomb code, truncated exponential Golomb code, etc.
      c) In one example, the first syntax element may be signaled conditionally.
         1. For example, the first syntax element may be signaled only if the extended taps are available.
      d) The first syntax element may be coded in a predictive way.
         1. The first syntax element may be predicted by the on/off decision of extended taps of at least one neighbouring block.
      e) The first syntax element may be signaled independently for different color components.
         1. Alternatively, the first syntax element may be signaled and shared for different color components.
         2. Alternatively, the first syntax element may be signaled for a first color component but not signaled for a second color component.
      i. A syntax element structure (such as an APS) may contain filters with extended taps.
         a) In one example, the coefficients of extended taps may be contained in an APS.
         b) In one example, the clipping parameters of extended taps may be contained in an APS.
         c) In one example, the class merging results of extended taps may be contained in an APS.
         d) Alternatively, other parameters of extended taps may be contained in an APS.
4) It is proposed to relax the geometric symmetrical constrain of the coefficients/clipping-parameters in ALF.
   a. In current ALF design, a coefficient and the corresponding clipping parameter is trained/generated based on two input samples as described in section 3.8. In the proposed method, a coefficient and the corresponding clipping parameter may be trained/generated based on one input sample.
   b. In one example, the geometric symmetrical constrain may be totally removed.
      a) In one example, considering that a diamond 5×5 filter shape is applied for one filter in ALF as shown in FIG. 17. FIG. 17 shows examples of a 5×5 diamond filter support in ALF.
      b) In one example, when the relaxation of symmetrical constrain is applied, the filter support may become the one shown in FIG. 18. FIG. 18 shows examples of a 5×5 diamond filter support in ALF with relaxation of symmetrical constrain.
      c) The total number of coefficients may be increased from 6 to 12.
      d) Alternatively, the total number of clipping parameters may be increased from 6 to 12.
   c. In one example, the geometric symmetrical constrain may be partially removed.
      a) In one example, considering that a diamond 5×5 filter shape is applied for one filter in ALF as shown in FIG. 5-1.
      b) In one example, the relaxation of symmetrical constrain may be applied to a diamond 3×3 area inside the filter shape.
         1. In one example, when the relaxation of symmetrical constrain is applied, the filter support may become the one shown in FIG. 19. FIG. 19 shows examples of a 5×5 diamond filter support in ALF with relaxation of symmetrical constrain.
         2. In one example, the number of coefficients may be increased from 6 to 8.
         3. Alternatively, the number of clipping parameters may be increased from 6 to 8.
      c) In one example, the relaxation of symmetrical constrain may be applied to a square 3×3 area inside the filter shape.
         1. In one example, when the relaxation of symmetrical constrain is applied, the filter support may become the one shown in FIG. 20. FIG. 20 shows examples of a 5×5 diamond filter support in ALF with relaxation of symmetrical constrain.
         2. In one example, the number of coefficients may be increased from 6 to 10.
         3. Alternatively, the number of clipping parameters may be increased from 6 to 10.
      d) In one example, the relaxation of symmetrical constrain may be applied to any area which could be covered by the filter shape of ALF.
   d. In one example, the relaxation of geometric symmetrical constrain may be applied to all components.
   e. Alternatively, the relaxation of geometric symmetrical constrain may be applied to one component.
      a) In one example, the relaxation of symmetrical constrain may be only applied to luma filters in ALF.
      b) In one example, the relaxation of symmetrical constrain may be only applied to chroma filters in ALF.
   f. In one example, the relaxation of geometric symmetrical constrain may be applied to both of spatial and extended/additional taps inside one ALF filter.
   g. Alternatively, the relaxation of geometric symmetrical constrain may be only applied to spatial or extended/additional taps inside one ALF filter.
      a) In one example, the relaxation of symmetrical constrain may be only applied to spatial taps inside one ALF filter.
      b) Alternatively, the relaxation of symmetrical constrain may be only applied to extended/additional taps inside one ALF filter.
   h. In one example, the asymmetrical taps may be performed as additional taps.
      a) In one example, the spatial asymmetrical taps may be performed as additional taps on top of symmetrical spatial taps.
      b) In one example, the spatial asymmetrical taps may be performed as additional taps on top of symmetrical extended taps.
      c) Alternatively, the extended asymmetrical taps may be performed as additional taps on top of symmetrical spatial taps.
      d) Alternatively, the extended asymmetrical taps may be performed as additional taps on top of symmetrical extended taps.
   i. In one example, the relaxation of geometric symmetrical constrain may have an on/off control.
      a) In one example, a flag in APS may be used for on/off control of relaxation of geometric symmetrical constrain.
      b) In one example, the on/off control may be signaled/inherited/derived on the fly.
5) In one example, the above-mentioned methods may be used jointly.
6) Alternatively, the above-mentioned methods may be used individually.
7) In one example, the proposed/described filter shape selection method may be applied to any in-loop filtering tools, pre-processing or post-processing filtering method in video coding (including but not limited to ALF/CCALF or any other filtering method).
   a. In one example, the proposed filter shape selection method may be applied to an in-loop filtering method.
      a) In one example, the proposed filter shape selection method may be applied to ALF.
      b) In one example, the proposed filter shape selection method may be applied to CCALF.
      c) Alternatively, the proposed filter shape selection method may be applied to other in-loop filtering methods.
   b. In one example, the proposed filter shape selection method may be applied to a pre-processing filtering method.
   c. In one example, the proposed filter shape selection method may be applied to a post-processing filtering method.
8) In above examples, the video unit may refer to sequence/picture/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/any other region that contains more than one luma or chroma sample/pixel.
9) Whether to and/or how to apply the disclosed methods above may be signalled in a bitstream.
   a. In one example, they may be signalled at sequence level/group of pictures level/picture level/slice level/tile group level, such as in sequence header/picture header/SPS/VPS/DPS/DCI/PPS/APS/slice header/tile group header.
   b. In one example, they may be signalled at PB/TB/CB/PU/TU/CU/VPDU/CTU/CTU row/slice/tile/sub-picture/other kinds of region contain more than one sample or pixel.
10) Whether to and/or how to apply the disclosed methods above may be dependent on coded information, such as block size, colour format, single/dual tree partitioning, colour component, slice/picture type.

As used herein, the term “video unit” may refer to a sequence, a picture, a sub-picture, a slice, a CTU, a block or a region. The video unit may comprise one color component or it may comprise multiple color components. The term “ALF processing unit” may refer to a sequence, a picture, a sub-picture, a slice, a CTU, a block, a region, or a sample. The ALF processing unit may comprise one color component or it may comprise multiple color components. Embodiments of the present disclosure may be applied to in-loop filters or post-processing. It is noted that embodiments of the present disclosure can be implemented separately. Alternatively, embodiments of the present disclosure can be implemented jointly. As used herein, the terms “picture” and “frame” can be interchangeable.

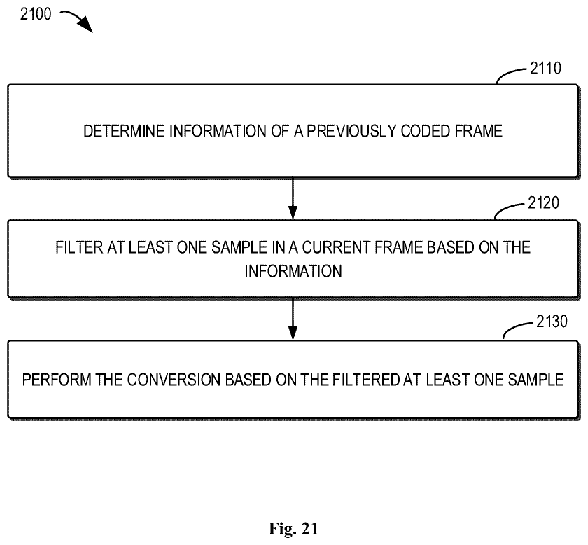

FIG. 21 illustrates a flowchart of a method 2100 for video processing in accordance with some embodiments of the present disclosure. The method 2100 may be implemented during a conversion between a video unit and a bit-stream of the video unit.

At block 2110, during a conversion between a video unit of a video and a bitstream of the video unit, information of a previously coded picture associated with the video unit is determined. In some embodiments, the information may include a set of reconstructed samples in the previously coded picture. Alternatively, or in addition, the information may include motion information of the previously coded picture.

At block 2120, during a filtering process, at least one sample of the video unit is filtered based on the information. For example, the filtering process comprises an adaptive loop filter (ALF). In some embodiments, the filtering process may include one of: an in-loop filtering method, a pre-processing filtering method, or a post-processing filtering method. In some embodiments, the in-loop filtering method includes at least one of: an ALF, a cross-component ALF, or another in-loop filter method.

At block 2130, the conversion is performed based on the filtered at least one sample. In some embodiments, the conversion may comprise encoding the video unit into the bitstream. In some embodiments, the conversion may comprise decoding the video unit from the bitstream. In this way, it can advantageously improve the coding efficiency and performance.

In some embodiments, a plurality of extended taps for ALF may be used based on one or more previously coded pictures. In some embodiments, the previously coded picture may be one of: a reference picture in a reference picture list (RPL), and wherein the RPL is associated with one of: a current block, a current slice, or the current picture; or a reference picture in a reference picture set (PRS), and wherein the PRS is associated with one of: the current block, the current slice, or the current picture. For example, the previously coded picture is a short-term reference picture of one of: the current block, the current slice, or the current picture. Alternatively, the previously coded picture may be a long-term reference picture of one of: the current block, the current slice, or the current picture.

In some embodiments, the previously coded picture is stored in a decoded picture buffer (DPB). In some embodiments, the previously coded picture is indicated by at least one indicator. For example, a reference picture list to be used is indicated by the at least one indicator. Alternatively, a reference index to be used is indicated by the at least one indicator. In some embodiments, the at least one indicator may be conditionally signaled. For example, the at least one indicator is indicated based on the number of reference pictures included in a RPL or RPS. Alternatively, the at least one indicator is indicated based on the number of previously decoded pictures included in a DPB.

In some embodiments, the previously coded picture to be used may be dynamically determined. For example, which pictures to be utilized is determined on-the-fly.

In some embodiments, a plurality extended taps may obtain/take information from one or more previously coded pictures in DPB. In one example, a plurality of extended taps obtains information from one or more previously coded pictures in list 0. Alternatively, the plurality of extended taps obtains information from one or more previously coded pictures in list 1. In some other embodiments, a plurality of extended taps obtains information from one or more previously coded pictures in list 0 and list 1.

In some embodiments, a plurality of extended taps obtains information from a reference picture that is closest to the current picture. In one example, the extended taps may take information from the reference picture closest (e.g., with smallest POC distance to current slice/picture) to the current picture.

In some embodiments, a plurality of extended taps obtains from a reference picture with a reference index equal to a value (for example, equal to K) in a reference list. For example, the value may be 0. In some embodiments, the value may be pre-defined. Alternatively, the value may be derived on the fly based on reference picture information. In some embodiments, the value may be indicated/signalled. In some embodiments, a plurality of extended taps may obtain/take information from a collocated picture. It is noted that the plurality of extended taps may include any proper number of extended taps.

In some embodiments, the previously coded picture to be used may be determined based on decoded information. In one example, the previously coded picture to be used may be defined as a top N most-frequently used reference pictures for samples within the current picture or a current slice, where N is an integer number. For example, N may be 1.

In some embodiments, the previously coded picture to be used may be defined as a top N most-frequently used reference picture of each reference picture list for samples within the current picture or a current slice, where N is an integer number. For example, N may be 1.

In some embodiments, the previously coded picture to be used may be defined as a picture with N smallest distance relative to a current picture, wherein N is an integer number. For example, the N smallest distance comprises N smallest picture order count (POC) distances. Alternatively, the N smallest distance comprises N smallest absolute POC distances. For example, N may be 1.

In some embodiments, whether to determine the information from the previously coded picture may be dependent on decoded information of at least one region of a current block to be filtered. The decoded information may include one or more of: coding modes, coding statistics, or coding characteristics. In some embodiments, whether to determine the information from the previously coded picture of at least one region of a current block may be indicated from an encoder to a decoder.

Alternatively, whether to determine the information from the previously coded picture is dependent on a slice type or a picture type. For example, if the slice type is an inter-coded slice or the picture type is an inter-coded picture, the information is determined from the previously coded picture. In one example, it may be only applicable to inter-coded slices/pictures (e.g., P or B slices/pictures).

In some embodiments, whether to determine the information from the previously coded picture may be dependent on availability of reference pictures. In some embodiments, whether to determine the information from the previously coded picture is dependent on reference picture information or picture information in a DPB. For example, if a smallest POC distance between a reference picture and a current picture is greater than a threshold, it is disabled that the information is determined from the previously coded picture. In one example, if the smallest POC distance (e.g., smallest POC distance between reference pictures/pictures in DPB and current picture) is greater than a threshold, it is disabled.

In some embodiments, whether to determine the information from the previously coded picture is dependent on at least one of: a temporal layer index, a quantization parameter (QP), or dimensions of a picture. For example, if the temporal layer index is a give temporal layer index, the information is determined from the previously coded picture. In one example, it may be applicable to blocks with a given temporal layer index (e.g., the highest temporal layer).

In some embodiments, if the video unit includes a portion of samples that are coded in a non-inter mode, a plurality of extended taps do not use information from the previously coded picture to filter the video unit. For example, the non-inter mode is defined as an intra mode. In some embodiments, the non-inter mode is defined as a set of coding mode which includes at least one of: an intra mode, an intra block copy (IBC) mode, or a Palette mode.

In some embodiments, a distortion between a current block and a matching block is determined, and the distortion is used to determine whether to determine the information from the previously coded picture to filter the current block. In one example, a distortion between current block and the matching block is calculated and used to decide whether to take information from previously coded pictures to filter current block.

In some embodiments, a distortion between a collocated block in the previously coded picture and the current block may be used to determine whether to determine the information from the previously coded picture to filter the current block. For example, motion estimation is used to find a matching block from the previously coded picture. In some embodiments, if the distortion is larger than a pre-defined threshold, the information determined from the previously coded picture is not used.

In some embodiments, the extended plurality of taps may obtain/take motion information of a current block and reconstructed samples in the previously coded picture to generate a reference block. In some embodiments, the reference block is at least one reference block of the current block. Alternatively, the reference block is at least one collocated block of the current block.

In some embodiments, the reference block is in a region pointed by at least one motion vector. For example, the motion vector may be different from the decoded motion vector associated with the current block. In some embodiments, the reference block is a block of which center is located at a same horizontal and vertical position in the previously coded picture as that of the current block in the current picture.

In some embodiments, the reference block is derived by motion estimation. For example, the motion estimation may include searching from the previously coded picture to find a block that is closest to the current block with a certain measure.

In some embodiments, the motion estimation is performed at an integer precision to avoid fractional pixel interpolation. Alternatively, the motion estimation is performed at fractional precision to improve a quality of reference block.

In some embodiments, the reference block is derived by reusing a motion vector included in the current block. In an example, the motion vector may be rounded to an integer precision to avoid fractional pixel interpolation.

In some embodiments, the reference block may be located by adding an offset which is determined by the motion vector to a position of the current block. For example, the motion vector refers to a previously coded picture including the reference block. Alternatively, the motion vector is scaled to a previously coded picture including the reference block.

In some embodiments, a size of at least one of: the reference block or a collocated block is same as a size of the current block. Alternatively, the size of the at least one of: the reference block or the collocated block is larger than the size of the current block.

In some embodiments, at least one of: the reference blocks or the collocated blocks with the same size of the current block may be first found and then extended at each boundary to include more samples from previously coded samples. For example, a size of extended area is indicated to a decoder. Alternatively, the size of extended area is dynamically derived. For example, the size of extended area may be derived on-the-fly.

In some embodiments, the information may include at least one of: two reference blocks or two collocated blocks of the current block. In this case, one of the two reference blocks is from a first reference picture in list 0, and the other of the two reference blocks is from the first reference picture in list 1. Alternatively, one of the two collocated blocks is from the first reference picture in list 0, and the other of the two collocated blocks is from the first reference picture in list 1.

In some embodiments, a plurality of extended taps for ALF may be utilized based on a cross-component concept. For example, several extended taps for ALF may be used based on the cross-component concept. It is noted using several extended taps for ALF based on the cross-component concept can be implemented independently or together with filtering the sample in the current picture based on information in the previously coded picture. In this way, the cross-component based concept can benefit the Luma filter of ALF. It is noted that the plurality of extended taps may include any proper number of taps.

In some embodiments, the plurality of extended taps may obtain/take information of Chroman components in a current picture or a current slice to filter Luma samples. In some embodiments, the plurality of extended taps may obtain information of Cb or Cr component from a source picture or a source slice.

In some embodiments, the plurality of extended taps may obtain information of both Chroma components from a source picture or a slice. In some embodiments, the plurality of extended taps may obtain information of Chroma components in the previously coded picture or a previously coded slice to filter Luma samples.

In some embodiments, the plurality of extended taps only obtains information of Cb or Cr component from a source picture or a source slice. In some embodiments, the plurality of extended taps may obtain information of both Chroma component from a source picture or a source slice.

In some embodiments, the previously coded picture or slice to be used is dynamically determined. Alternatively, the previously coded picture or slice to be used is indicated/signalled. Alternatively, the previously coded picture or slice to be used is derived. The previously coded picture or slice to be used may be determined following the way mentioned in above embodiments.

In some embodiments, whether to use the previously coded picture or slice is dynamically determined. In some embodiments, whether to use the previously coded picture or slice is indicated. In some embodiments, whether to use the previously coded picture or slice is derived. Whether to use the previously coded picture or slice may be determined following the way mentioned in above embodiments.

In some embodiments, the plurality of extended taps may obtain information of Luma component in a current picture or a current slice to filter Chroma samples. In some embodiments, the plurality of extended taps may be applied to filter Cb or Cr component. In some embodiments, the plurality of extended taps may be applied to filter both of Chroma components.

In some embodiments, the plurality of extended taps may obtain information of Luma component in the previously coded picture or slice to filter Chroma samples. In some embodiments, the plurality of extended taps may be only applied to filter Cb or Cr component. In some embodiments, the plurality of extended taps may be applied to filter both of Chroma component.

In some embodiments, the previously coded picture or slice to be used is dynamically determined. In some embodiments, the previously coded picture or slice to be used is indicated. In some embodiments, the previously coded picture or slice to be used is derived. The previously coded picture or slice to be used may be determined following the way mentioned in above embodiments.

In some embodiments, whether to use the previously coded picture or slice is dynamically determined. In some embodiments, whether to use the previously coded picture or slice is indicated. In some embodiments, whether to use the previously coded picture or slice is derived. Whether to use the previously coded picture or slice may be determined following the way mentioned in above embodiments.

In some embodiments, the plurality of extended taps may obtain/take information of a first chroma component in a current picture or slice to filter Chroma samples of a second chroma component. In some embodiments, the plurality of extended taps may obtain information of a first chroma component in the previously coded picture or slice to filter Chroma samples of a second chroma component. In some embodiments, the previously coded picture or slice to be used is dynamically determined. In some embodiments, the previously coded picture or slice to be used is indicated. In some embodiments, the previously coded picture or slice to be used is derived. The previously coded picture or slice to be used may be determined following the way mentioned in above embodiments.

In some embodiments, whether to use the previously coded picture or slice is dynamically determined. In some embodiments, whether to use the previously coded picture or slice is indicated. In some embodiments, whether to use the previously coded picture or slice may be derived. whether to use the previously coded picture or slice may be determined following the way mentioned in above embodiments.

In some embodiments, a plurality of extended taps for ALF are used. For example, the plurality of extended taps may be different from spatial taps in ALF that only utilize information of spatial neighbor samples of a filtering component. In some embodiments, only spatial neighbor luma samples are used to filter a central luma sample inside one filter shape.

In some embodiments, the plurality of extended taps may be applied to different color components. In some embodiments, the plurality of extended taps may be applied to both of Luma and Chroma components. Alternatively, the plurality of extended taps are only applied to Luma component. In some embodiments, the plurality of extended taps are only applied to Chroma component.

In one example, Ŝ(x,y)=F({S_{i,j}(x,y)}, {E_{m,n}(x, y)}), where Ŝ(x,y) is a sample at (x, y) after filtering, {S_{i,j}(x, y)} is a set of samples corresponding to spatial taps, {E_{m,n}(x, y)} is a set of samples corresponding to extended taps and F is a joint filtering function. Alternatively, (x, y)=G(F({S_{i,j}(x, y)}), {E_{m,n}(x, y)}), F is a first stage filtering function applied on spatial taps only and G is a second stage filtering function. Alternatively, Ŝ(x, y)=G({S_{i,j}(x, y)}, F({E_{m,n}(x, y)})), F is a first stage filtering function applied on extended taps only and G is a second stage filtering function. Alternatively, Ŝ(x, y)=K(F({S_{i,j}(x, y)}), G ({E_{m,n}(x, y)}), F is a first filtering function applied on spatial taps only and G is a second filtering function applied on extended taps only and K is a joint filtering function.

In some embodiments, the plurality of extended taps are used as additional taps of a filter shape in ALF. In some embodiments, the plurality of extended taps may be combined with spatial taps to form a filter. In some embodiments, training data collection for a plurality of extended and spatial taps are performed jointly. In some embodiments, coefficients of a plurality of extended and spatial taps are trained jointly. In some embodiments, clipping parameters of a plurality extended and spatial taps are generated jointly. In some embodiments, other parameters of extended and spatial taps are derived jointly.

In some embodiments, the plurality of extended taps are used as an independent filter in ALF. In some embodiments, the plurality of extended taps are performed as an independent filter. In some embodiments, training data collection for the plurality of extended taps are performed individually. In some embodiments, the training data collection for the plurality of extended taps are performed based on ALF-unfiltered samples. In some embodiments, the training data collection for the plurality of extended taps are performed based on ALF-filtered samples. In some embodiments, coefficients of the plurality of extended taps are trained individually. In some embodiments, clipping parameters of the plurality of extended taps are generated or derived individually. In some embodiments, other parameters of the plurality of extended taps are derived independently.

In some embodiments, the plurality of extended taps use different shapes or sizes.

In some embodiments, spatial taps of one filter use a diamond shape with a first size and extended taps use a diamond shape with a second size, the extended taps are used in both forward and backward reference slice or reference picture. The first size may be 9 and the second size is 5. In one example, the spatial taps and extended taps of one filter may distribute as shown in FIG. 16. The spatial taps may use a diamond shape with size of 9 while the extended taps may use a diamond shape with size of 5. The extended taps may be used in both of forward and backward reference slice/picture.

In some embodiments, the plurality of extended taps may use one of: a diamond shape, a square shape, a cross shape, a symmetrical shape, an asymmetrical shape, another shape. In some embodiments, a shape of the plurality of extended taps may be dynamically determined. In some embodiments, the shape of the plurality of extended taps are indicated. In some embodiments, the shape of the plurality of extended taps are derived. In one example, the shape of extended taps may be determined on the fly/signalled/derived.

In some embodiments, the plurality of extended taps uses a filter length equal to a value. In one example, the extended taps may use filter length equal to N (e.g. N=3).

In some embodiments, the filter length of the plurality of extended taps is dynamically determined. In some embodiments, the filter length is indicated. In some embodiments, the filter length is derived. In one example, the filter length of extended taps may be determined on the fly/signalled/derived.

In some embodiments, a symmetrical constrain is performed on the plurality of extended taps. In some embodiments, a geometric symmetrical constrain is performed on the plurality of extended taps. In some embodiments, a temporal symmetrical constrain is performed on extended taps if a plurality of reference blocks are used.

In some embodiments, a geometric and temporal symmetrical constrain is performed individually. In some embodiments, a geometric and temporal symmetrical constrain is performed jointly. In some embodiments, a total number of extended taps is derived based on a shape, a filter length, a symmetrical constrain jointly.

In some embodiments, a center of a filtering shape of extended taps is at a same position of a current sample to be filtered but is in different pictures. In some embodiments, a center of the filtering shape of the extended taps is at a different position of the current sample and is in different pictures. The center (at position A) of the filtering shape of the extended taps may be at a different position of the current sample (at position B) to be filtered, and maybe in different pictures.

In some embodiments, a between the center and a position of the current sample is determined by a motion vector. In some embodiments, the motion vector is rounded to integer samples. In some embodiments, the motion vector is scaled to a required reference picture.

In some embodiments, the motion vector is derived by a motion vector (MV) of a block covering a current sample, and the block is one of: a prediction unit (PU), a coding unit (CU), or a coding tree unit (CTU).

In some embodiments, if there is no MV of the block covering the current sample, a default MV is used. In one example, if there is no MV of the block covering the current sample (such as intra-coded), a default one may be used, such as (0,0).

In some embodiments, if there is no MV of the block covering the current sample, a replacement MV is used, and the replacement MV is derived from a neighboring block with a MV. In some embodiments, if there is a plurality of MVs of the block covering the current sample, one of the plurality of MVs is used. In some embodiments, a MV at a center of the block is used.

In some embodiments, a classification for the plurality of extended taps is performed. In some embodiments, the classification for the plurality of extended taps is be performed based on texture information. In some embodiments, the classification for extended taps is performed based on band information.

In some embodiments, a classification for spatial taps is reused for the plurality of extended taps. In some embodiments, a class merging for the plurality of extended taps is performed independently. In some embodiments, a class merging for spatial taps is reused for the plurality of extended taps.

In some embodiments, a first syntax element is indicated to indicate whether the plurality of extended taps may be enabled. In some embodiments, the first syntax element is coded by an arithmetic coding. In some embodiments, first syntax element is coded with at least one context. In some embodiments, the context depends on coding information of the current block or a neighboring block. In some embodiments, the context depends on a filtering shape of at least one neighboring block.

In some embodiments, the first syntax element is coded with bypass coding. In some embodiments, the first syntax element is binarized by one of: a unary code, a truncated unary code, a fixed-length code, an exponential Golomb code, or a truncated exponential Golomb code.

In some embodiments, the first syntax element indicated conditionally. In some embodiments, the first syntax element is indicated only if the plurality of extended taps may be available. In some embodiments, the first syntax element is coded in a predictive way. In some embodiments, the first syntax element is predicted by an on/off decision of extended taps of at least one neighboring block. In some embodiments, the first syntax element is indicated independently for different color components. In some embodiments, the first syntax element is indicated and shared for different color components. In some embodiments, the first syntax element is indicated for a first color component but not indicated for a second color component.

In some embodiments, a syntax element structure includes filters with extended taps. In some embodiments, coefficients of extended taps are included in the syntax element structure. In some embodiments, clipping parameters of extended taps are included in the syntax element structure. In some embodiments, class merging results of extended taps are included in the syntax element structure. In some embodiments, parameters of extended taps are included in the syntax element structure. In some embodiments, the syntax element structure is an adaptation parameter set (APS).

In some embodiments, an indication of whether to and/or how to filter the at least one sample based on the information may be in the bitstream. For example, an indication of whether to and/or how to filter the at least one sample in the current picture based on the information is indicated at one of the followings: a sequence level, a group of pictures level, a picture level, a slice level, or a tile group level.

In some embodiments, an indication of whether to and/or how to filter the at least one sample based on the information is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

In some embodiments, an indication of whether to and/or how to filter the at least one sample based on the information is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to filter the at least one sample may be determined based on the information. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by a video processing apparatus. The method includes determining information of a previously coded picture associated with a video unit of the video; during a filtering process, filtering at least one sample of the video unit based on the information; and generating a bitstream of the target block based on the filtered at least one sample.

According to still further embodiments of the present disclosure, a method for storing bitstream of a video is provided. The method comprises: determining information of a previously coded picture associated with a video unit of the video; during a filtering process, filtering at least one sample of the video unit based on the information; generating a bitstream of the target block based on the filtered at least one sample; and storing the bitstream in a non-transitory computer-readable recording medium.

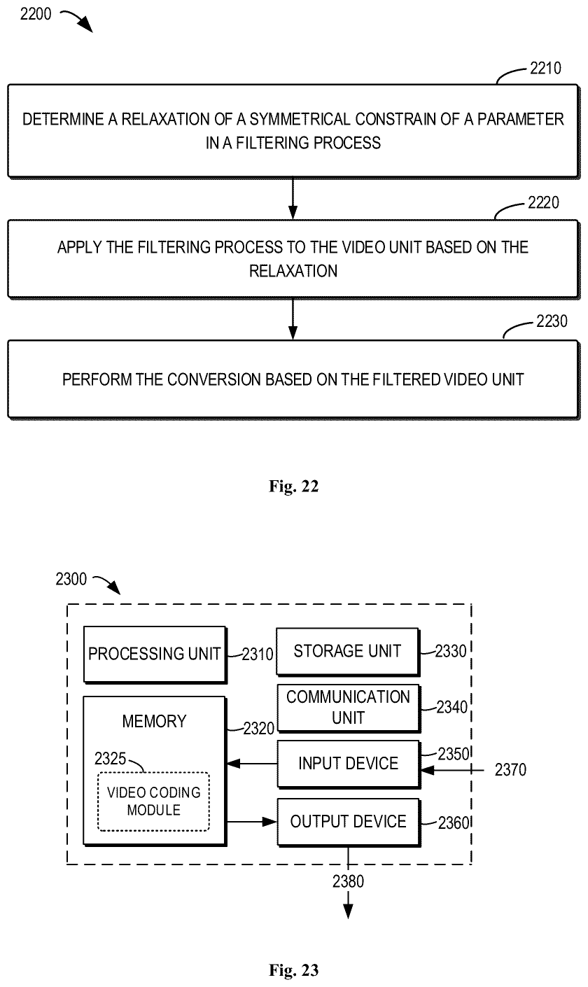

FIG. 22 illustrates a flowchart of a method 2200 for video processing in accordance with some embodiments of the present disclosure. The method 2200 may be implemented during a conversion between a video unit and a bit-stream of the video unit.

At block 2210, during a conversion between a video unit and a bitstream of the video unit, a relaxation of a symmetrical constrain of a parameter in a filtering process is determined. In some embodiments, the parameter comprises at least one of: a coefficient or a clipping parameter. In some embodiments, the symmetrical constrain comprises a geometric symmetrical constrain. In some embodiments, the parameter comprises: a coefficient and a corresponding clipping parameter, and the coefficient and the corresponding clipping parameter are trained or generated based on an input sample.

At block 2220, the filtering process is applied to the video unit based on the relaxation. For example, the filtering process comprises an adaptive loop filter (ALF). In some embodiments, the filtering process may include one of: an in-loop filtering method, a pre-processing filtering method, or a post-processing filtering method. In some embodiments, the in-loop filtering method includes at least one of: an ALF, a cross-component ALF, or another in-loop filter method.

At block 2230, the conversion is performed based on the filtered video unit. In some embodiments, the conversion may comprise encoding the video unit into the bitstream. In some embodiments, the conversion may comprise decoding the video unit from the bitstream. In this way, it can advantageously improve the coding efficiency and performance.

In some embodiments, the relaxation comprises that the symmetrical constrain is totally removed. In some embodiments, the relaxation of symmetrical constrain is applied to a diamond with a first size filter shape. In some embodiments, a total number of coefficients is increased from a first value to a second value. In some embodiments, a total number of clipping parameters is increased from the first value to the second value. In one example, considering that a diamond 5×5 filter shape is applied for one filter in ALF as shown in FIG. 17. In one example, when the relaxation of symmetrical constrain is applied, the filter support may become the one shown in FIG. 18. The total number of coefficients may be increased from 6 to 12. Alternatively, the total number of clipping parameters may be increased from 6 to 12.

In some embodiments, the relaxation comprises that the symmetrical constrain is partially removed. In some embodiments, a diamond with a first size filter shape is applied for one filter in the filtering process, and the relaxation of symmetrical constrain is applied to a diamond with a second size area inside the diamond with the first size filter shape. In this case, the second size may be smaller than the first size. In some embodiments, the number of coefficients is increased from a third value to a fourth value. In some embodiments, the number of clipping parameters is increased from the third value to the fourth value. In one example, the geometric symmetrical constrain may be partially removed. In one example, considering that a diamond 5×5 filter shape is applied for one filter in ALF as shown in FIG. 16. In one example, the relaxation of symmetrical constrain may be applied to a diamond 3×3 area inside the filter shape. In one example, when the relaxation of symmetrical constrain is applied, the filter support may become the one shown in FIG. 19. 2. In one example, the number of coefficients may be increased from 6 to 8. Alternatively, the number of clipping parameters may be increased from 6 to 8.

In some embodiments, the relaxation of symmetrical constrain is applied to a square with a third size area inside a filter shape. In some embodiments, the number of coefficients is increased from a fifth value to a sixth value. In some embodiments, the number of clipping parameters is increased from the fifth value to the sixth value. In one example, the relaxation of symmetrical constrain may be applied to a square 3×3 area inside the filter shape. In one example, when the relaxation of symmetrical constrain is applied, the filter support may become the one shown in FIG. 20. In one example, the number of coefficients may be increased from 6 to 10. Alternatively, the number of clipping parameters may be increased from 6 to 10.

In some embodiments, the relaxation of symmetrical constrain is applied to an area which is able to be covered by a filter shape of the filtering process. In some embodiments, the relaxation of symmetrical constrain is applied to all components. In some embodiments, the relaxation of symmetrical constrain is applied to one component. In some embodiments, the relaxation of symmetrical constrain is only applied to luma filters in the filtering process.

In some embodiments, the relaxation of symmetrical constrain is only applied to chroma filters in the filtering process. In some embodiments, the relaxation of symmetrical constrain is applied to both of spatial and extended taps inside one ALF filter. In some embodiments, the relaxation of symmetrical constrain is only applied to spatial or extended taps inside one ALF filter. In some embodiments, the relaxation of symmetrical constrain is only applied to spatial taps inside the ALF filter. In some embodiments, the relaxation of symmetrical constrain is only applied to extended taps inside the ALF filter.

In some embodiments, asymmetrical taps are performed as additional taps. In some embodiments, spatial asymmetrical taps are performed as additional taps on top of symmetrical spatial taps. In some embodiments, spatial asymmetrical taps are performed as additional taps on top of symmetrical extended taps. In some embodiments, extended asymmetrical taps are performed as additional taps on top of symmetrical spatial taps. In some embodiments, extended asymmetrical taps are performed as additional taps on top of symmetrical extended taps.

In some embodiments, there is an on/off control for the relaxation of symmetrical constrain. In some embodiments, a flag in APS is used for the on/off control of relaxation of symmetrical constrain. In some embodiments, the on/off control is indicated. In some embodiments, the on/off control is inherited. In some embodiments, the on/off control is dynamically derived.

In some embodiments, an indication of whether to and/or how to determine the relaxation of the symmetrical constrain is in the bitstream. For example, an indication of whether to and/or how to determine the relaxation of the symmetrical constrain is indicated at one of the followings: a sequence level, a group of pictures level, a picture level, a slice level, or a tile group level.

In some embodiments, an indication of whether to and/or how to determine the relaxation of the symmetrical constrain is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

In some embodiments, an indication of whether to and/or how to determine the relaxation of the symmetrical constrain is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether to and/or how to determine the relaxation of the symmetrical constrain may be determined based on the coded information. The coded information may include at least one of: a block size, a colour format, a single and/or dual tree partitioning, a colour component, a slice type, or a picture type.

During the filtering process, at least one of: filtering at least one sample based on the information or the relaxation of the symmetrical constrain may be applied. In some embodiments, a filter shape selection method is applied to the filtering process is one of the followings in video coding: an in-loop filtering method, a pre-processing filtering method, or a post-processing filtering method.

In some embodiments, the in-loop filtering method comprises at least one of: an ALF, a cross-component ALF, or another in-loop filter method.

In some embodiments, the video unit comprises one of: a sequence, a picture, a sub-picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), or a region that contains more than one luma or chroma sample or pixel.

According to further embodiments of the present disclosure, a non-transitory computer-readable recording medium is provided. The non-transitory computer-readable recording medium stores a bitstream of a video which is generated by a method performed by a video processing apparatus. The method comprises: determining a relaxation of a symmetrical constrain of a parameter in a filtering process; applying the filtering process to a video unit of the video based on the relaxation; and generating a bitstream of the target block based on the filtered video unit.

According to still further embodiments of the present disclosure, a method for storing bitstream of a video is provided. The method comprises: determining a relaxation of a symmetrical constrain of a parameter in a filtering process; applying the filtering process to a video unit of the video based on the relaxation; generating a bitstream of the target block based on the filtered video unit; and storing the bitstream in a non-transitory computer-readable recording medium.

Implementations of the present disclosure can be described in view of the following clauses, the features of which can be combined in any reasonable manner.

Clause 1. A method of video processing, comprising: determining, during a conversion between a video unit of a current picture of a video and a bitstream of the video unit, information of a previously coded picture associated with the video unit; during a filtering process, filtering at least one sample of the video unit based on the information; and performing the conversion based on the filtered at least one sample.

Clause 2. The method of clause 1, wherein the filtering process comprises an adaptive loop filter (ALF).

Clause 3. The method of clause 1, wherein the information comprises at least one of: a set of reconstructed samples in the previously coded picture, or motion information of the previously coded picture.

Clause 4. The method of clause 1, wherein a plurality of extended taps for ALF are used based on one or more previously coded pictures.

Clause 5. The method of clause 1, wherein the previously coded picture is one of: a reference picture in a reference picture list (RPL), and wherein the RPL is associated with one of: a current block, a current slice, or the current picture; or a reference picture in a reference picture set (PRS), and wherein the PRS is associated with one of: the current block, the current slice, or the current picture.

Clause 6. The method of clause 5, wherein the previously coded picture is a short-term reference picture of one of: the current block, the current slice, or the current picture, or wherein the previously coded picture is a long-term reference picture of one of: the current block, the current slice, or the current picture.

Clause 7. The method of clause 1, wherein the previously coded picture is stored in a decoded picture buffer (DPB).

Clause 8. The method of clause 1, wherein the previously coded picture is indicated by at least one indicator.

Clause 9. The method of clause 8, wherein a reference picture list to be used is indicated by the at least one indicator.

Clause 10. The method of clause 8, wherein a reference index to be used is indicated by the at least one indicator.

Clause 11. The method of clause 8, wherein the at least one indicator is indicated based on the number of reference pictures included in a RPL or RPS.

Clause 12. The method of clause 8, wherein the at least one indicator is indicated based on the number of previously decoded pictures included in a DPB.

Clause 13. The method of clause 1, wherein the method further comprises: dynamically determining the previously coded picture to be used.

Clause 14. The method of clause 1, wherein a plurality extended taps obtains information from one or more previously coded pictures in DPB.

Clause 15. The method of clause 1, wherein a plurality of extended taps obtains information from one or more previously coded pictures in list 0, or wherein the plurality of extended taps obtains information from one or more previously coded pictures in list 1.

Clause 16. The method of clause 1, wherein a plurality of extended taps obtains information from one or more previously coded pictures in list 0 and list 1.

Clause 17. The method of clause 1, wherein a plurality of extended taps obtains information from a reference picture that is closest to the current picture.

Clause 18. The method of clause 1, wherein a plurality of extended taps obtains from a reference picture with a reference index equal to a value in a reference list.

Clause 19. The method of clause 18, wherein the value is 0, or wherein the value is pre-defined, or wherein the value is derived on the fly based on reference picture information, or wherein the value is indicated.

Clause 20. The method of clause 1, wherein a plurality of extended taps obtains information from a collocated picture.

Clause 21. The method of clause 1, wherein the method further comprises: determining the previously coded picture to be used based on decoded information.

Clause 22. The method of clause 21, wherein the previously coded picture to be used is defined as a top N most-frequently used reference pictures for samples within the current picture or a current slice, wherein N is an integer number.

Clause 23. The method of clause 21, wherein the previously coded picture to be used is defined as a top N most-frequently used reference picture of each reference picture list for samples within the current picture or a current slice, wherein N is an integer number.

Clause 24. The method of clause 21, wherein the previously coded picture to be used is defined as a picture with N smallest distance relative to a current picture, wherein N is an integer number.

Clause 25. The method of clause 24, wherein the N smallest distance comprises N smallest picture order count (POC) distances, or wherein the N smallest distance comprises N smallest absolute POC distances.

Clause 26. The method of clause 1, wherein whether to determine the information from the previously coded picture is dependent on decoded information of at least one region of the a current block to be filtered.

Clause 27. The method of clause 1, wherein whether to determine the information from the previously coded picture of at least one region of a current block is indicated from an encoder to a decoder.

Clause 28. The method of clause 1, wherein whether to determine the information from the previously coded picture is dependent on a slice type or a picture type.

Clause 29. The method of clause 28, wherein if the slice type is an inter-coded slice or the picture type is an inter-coded picture, the information is determined from the previously coded picture.

Clause 30. The method of clause 1 wherein whether to determine the information from the previously coded picture is dependent on availability of reference pictures.

Clause 31. The method of clause 1, wherein whether to determine the information from the previously coded picture is dependent on reference picture information or picture information in a DPB.

Clause 32. The method of clause 31, wherein if a smallest POC distance between a reference picture and a current picture is greater than a threshold, it is disabled that the information is determined from the previously coded picture.

Clause 33. The method of clause 1, wherein whether to determine the information from the previously coded picture is dependent on at least one of: a temporal layer index, a quantization parameter (QP), or dimensions of a picture.

Clause 34. The method of clause 33, wherein if the temporal layer index is a give temporal layer index, the information is determined from the previously coded picture.

Clause 35. The method of clause 1, wherein if the video unit includes a portion of samples that are coded in a non-inter mode, a plurality of extended taps do not use information from the previously coded picture to filter the video unit.

Clause 36. The method of clause 35, wherein the non-inter mode is defined as an intra mode.

Clause 37. The method of clause 35, wherein the non-inter mode is defined as a set of coding mode which includes at least one of: an intra mode, an intra block copy (IBC) mode, or a Palette mode.

Clause 38. The method of clause 1, wherein a distortion between a current block and a matching block is determined, and wherein the distortion is used to determine whether to determine the information from the previously coded picture to filter the current block.

Clause 39. The method of clause 38, wherein a distortion between a collocated block in the previously coded picture and the current block is used to determine whether to determine the information from the previously coded picture to filter the current block.

Clause 40. The method of clause 38, wherein motion estimation is used to find a matching block from the previously coded picture.

Clause 41. The method of clause 38, wherein if the distortion is larger than a pre-defined threshold, the information determined from the previously coded picture is not used.

Clause 42. The method of clause 1, wherein the extended plurality of taps obtains motion information of a current block and reconstructed samples in the previously coded picture to generate a reference block.

Clause 43. The method of clause 42, wherein the reference block is at least one reference block of the current block, or wherein the reference block is at least one collocated block of the current block.

Clause 44. The method of clause 42, wherein the reference block is in a region pointed by at least one motion vector.

Clause 45. The method of clause 44, wherein the motion vector is different from the decoded motion vector associated with the current block.

Clause 46. The method of clause 42, wherein the reference block is a block of which center is located at a same horizontal and vertical position in the previously coded picture as that of the current block in the current picture.

Clause 47. The method of clause 42, wherein the reference block is derived by motion estimation.

Clause 48. The method of clause 47, wherein the motion estimation comprises searching from the previously coded picture to find a block that is closest to the current block with a certain measure.

Clause 49. The method of clause 47, wherein the motion estimation is performed at an integer precision to avoid fractional pixel interpolation.

Clause 50. The method of clause 47, wherein the motion estimation is performed at fractional precision to improve a quality of reference block.

Clause 51. The method of clause 42, wherein the reference block is derived by reusing a motion vector included in the current block.

Clause 52. The method of clause 51, wherein the motion vector is rounded to an integer precision to avoid fractional pixel interpolation.

Clause 53. The method of clause 51, wherein the reference block is located by adding an offset which is determined by the motion vector to a position of the current block.

Clause 54. The method of clause 51, wherein the motion vector refers to a previously coded picture including the reference block.

Clause 55. The method of clause 51, wherein the motion vector is scaled to a previously coded picture including the reference block.

Clause 56. The method of clause 42, wherein a size of at least one of: the reference block or a collocated block is same as a size of the current block, or wherein the size of the at least one of: the reference block or the collocated block is larger than the size of the current block.

Clause 57. The method of clause 56, wherein at least one of: the reference blocks or the collocated blocks with the same size of the current block is first found and then extended at each boundary to include more samples from previously coded samples.

Clause 58. The method of clause 57, wherein a size of extended area is indicated to a decoder, or wherein the size of extended area is dynamically derived.

Clause 59. The method of clause 42, wherein the information comprises at least one of: two reference blocks or two collocated blocks of the current block, and wherein one of the two reference blocks is from a first reference picture in list 0, and the other of the two reference blocks is from the first reference picture in list 1, or wherein one of the two collocated blocks is from the first reference picture in list 0, and the other of the two collocated blocks is from the first reference picture in list 1.

Clause 60. The method of clause 1, wherein a plurality of extended taps for ALF are utilized based on a cross-component concept.

Clause 61. The method of clause 60, wherein the plurality of extended taps obtain information of Chroman components in a current picture or a current slice to filter Luma samples.

Clause 62. The method of clause 60, wherein the plurality of extended taps obtain information of Cb or Cr component from a source picture or a source slice.

Clause 63. The method of clause 60, wherein the plurality of extended taps obtain information of both Chroma components from a source picture or a slice.

Clause 64. The method of clause 60, wherein the plurality of extended taps obtain information of Chroma components in the previously coded picture or a previously coded slice to filter Luma samples.

Clause 65. The method of clause 60, wherein the plurality of extended taps only obtains information of Cb or Cr component from a source picture or a source slice.

Clause 66. The method of clause 60, wherein the plurality of extended taps obtain information of both Chroma component from a source picture or a source slice.

Clause 67. The method of clause 60, wherein the previously coded picture or slice to be used is dynamically determined, or wherein the previously coded picture or slice to be used is indicated, or wherein the previously coded picture or slice to be used is derived.

Clause 68. The method of clause 60, wherein whether to use the previously coded picture or slice is dynamically determined, or wherein whether to use the previously coded picture or slice is indicated, or wherein whether to use the previously coded picture or slice is derived.

Clause 69. The method of clause 60, wherein the plurality of extended taps obtain information of Luma component in a current picture or a current slice to filter Chroma samples.

Clause 70. The method of clause 69, wherein the plurality of extended taps are applied to filter Cb or Cr component.

Clause 71. The method of clause 69, wherein the plurality of extended taps are applied to filter both of Chroma components.

Clause 72. The method of clause 60, wherein the plurality of extended taps obtain information of Luma component in the previously coded picture or slice to filter Chroma samples.

Clause 73. The method of clause 72, wherein the plurality of extended taps are only applied to filter Cb or Cr component.

Clause 74. The method of clause 72, wherein the plurality of extended taps are applied to filter both of Chroma component.

Clause 75. The method of clause 72, wherein the previously coded picture or slice to be used is dynamically determined, or wherein the previously coded picture or slice to be used is indicated, or wherein the previously coded picture or slice to be used is derived.

Clause 76. The method of clause 72, wherein whether to use the previously coded picture or slice is dynamically determined, or wherein whether to use the previously coded picture or slice is indicated, or wherein whether to use the previously coded picture or slice is derived.

Clause 77. The method of clause 60, wherein the plurality of extended taps obtain information of a first chroma component in a current picture or slice to filter Chroma samples of a second chroma component.

Clause 78. The method of clause 60, wherein the plurality of extended taps obtain information of a first chroma component in the previously coded picture or slice to filter Chroma samples of a second chroma component.

Clause 79. The method of clause 78, wherein the previously coded picture or slice to be used is dynamically determined, or wherein the previously coded picture or slice to be used is indicated, or wherein the previously coded picture or slice to be used is derived.

Clause 80. The method of clause 78, wherein whether to use the previously coded picture or slice is dynamically determined, or wherein whether to use the previously coded picture or slice is indicated, or wherein whether to use the previously coded picture or slice is derived.

Clause 81. The method of clause 1, wherein a plurality of extended taps for ALF are used.

Clause 82. The method of clause 81, wherein the plurality of extended taps are different from spatial taps in ALF that only utilize information of spatial neighbor samples of a filtering component.

Clause 83. The method of clause 82, wherein only spatial neighbor luma samples are used to filter a central luma sample inside one filter shape.

Clause 84. The method of clause 81, wherein the plurality of extended taps are applied to different color components.

Clause 85. The method of clause 84, wherein the plurality of extended taps are applied to both of Luma and Chroma components, or wherein the plurality of extended taps are only applied to Luma component, or wherein the plurality of extended taps are only applied to Chroma component.

Clause 86. The method of clause 81, wherein Ŝ(x,y)=F({S_{i,j}(x,y)},{E_{m,n}(x, y)}), wherein Ŝ(x,y) represents a sample at (x,y) after filtering, {S_{i,j}(x,y)} represents a set of samples corresponding to spatial taps, {E_{m,n}(x, y)} represents a set of samples corresponding to extended taps, F represents a joint filtering function, or x and y represent parameters.

Clause 87. The method of clause 86, wherein Ŝ(x, y)=G (F({S_{i,j}(x, y)}), {E_{m,n}(x, y)}), F represents a first stage filtering function applied on spatial taps only and G represents a second stage filtering function.

Clause 88. The method of clause 86, wherein Ŝ(x, y)=G({S_{i,j}(x, y)}, F({E_{m,n}(x,y)})), F represents a first stage filtering function applied on extended taps only and G represents a second stage filtering function.

Clause 89. The method of clause 86, wherein Ŝ(x, y)=K(F({S_{i,j}(x, y)}), G({E_{m,n}(x, y)}), F represents a first filtering function applied on spatial taps only and represents is a second filtering function applied on extended taps only and K represents a joint filtering function.

Clause 90. The method of clause 81, wherein the plurality of extended taps are used as additional taps of a filter shape in ALF.

Clause 91. The method of clause 90, wherein the plurality of extended taps are combined with spatial taps to form a filter.

Clause 92. The method of clause 90, wherein training data collection for a plurality of extended and spatial taps are performed jointly.

Clause 93. The method of clause 90, wherein coefficients of a plurality of extended and spatial taps are trained jointly.

Clause 94. The method of clause 90, wherein clipping parameters of a plurality extended and spatial taps are generated jointly.

Clause 95. The method of clause 90, wherein other parameters of extended and spatial taps are derived jointly.

Clause 96. The method of clause 81, wherein the plurality of extended taps are used as an independent filter in ALF.

Clause 97. The method of clause 96, wherein the plurality of extended taps are performed as an independent filter.

Clause 98. The method of clause 96, wherein training data collection for the plurality of extended taps are performed individually.

Clause 99. The method of clause 98, wherein the training data collection for the plurality of extended taps are performed based on ALF-unfiltered samples.

Clause 100. The method of clause 98, wherein the training data collection for the plurality of extended taps are performed based on ALF-filtered samples.

Clause 101. The method of clause 96, wherein coefficients of the plurality of extended taps are trained individually.

Clause 102. The method of clause 96, wherein clipping parameters of the plurality of extended taps are generated or derived individually.

Clause 103. The method of clause 96, wherein other parameters of the plurality of extended taps are derived independently.

Clause 104. The method of clause 81, wherein the plurality of extended taps use different shapes or sizes.

Clause 105. The method of clause 104, wherein spatial taps of one filter use a diamond shape with a first size and extended taps use a diamond shape with a second size, and wherein the extended taps are used in both forward and backward reference slice or reference picture.

Clause 106. The method of clause 105, wherein the first size is 9 and the second size is 5.

Clause 107. The method of clause 104, wherein the plurality of extended taps use one of: a diamond shape, a square shape, a cross shape, a symmetrical shape, an asymmetrical shape, another shape.

Clause 108. The method of clause 104, wherein a shape of the plurality of extended taps are dynamically determined, or wherein the shape of the plurality of extended taps are indicated, or wherein the shape of the plurality of extended taps are derived.

Clause 109. The method of clause 104, wherein the plurality of extended taps uses a filter length equal to a value.

Clause 110. The method of clause 109, wherein the filter length of the plurality of extended taps is dynamically determined, or wherein the filter length is indicated, or wherein the filter length is derived.

Clause 111. The method of clause 104, wherein a symmetrical constrain is performed on the plurality of extended taps.

Clause 112. The method of clause 111, wherein a geometric symmetrical constrain is performed on the plurality of extended taps.

Clause 113. The method of clause 111, wherein a temporal symmetrical constrain is performed on extended taps if a plurality of reference blocks are used.

Clause 114. The method of clause 111, wherein a geometric and temporal symmetrical constrain is performed individually.

Clause 115. The method of clause 111, wherein a geometric and temporal symmetrical constrain is performed jointly.

Clause 116. The method of clause 104, wherein a total number of extended taps is derived based on a shape, a filter length, a symmetrical constrain jointly.

Clause 117. The method of clause 104, wherein a center of a filtering shape of extended taps is at a same position of a current sample to be filtered but is in different pictures.

Clause 118. The method of clause 117, wherein a center of the filtering shape of the extended taps is at a different position of the current sample and is in different pictures.

Clause 119. The method of clause 118, wherein a between the center and a position of the current sample is determined by a motion vector.

Clause 120. The method of clause 119, wherein the motion vector is rounded to integer samples, or wherein the motion vector is scaled to a required reference picture.

Clause 121. The method of clause 119, wherein the motion vector is derived by a motion vector (MV) of a block covering a current sample, and wherein the block is one of: a prediction unit (PU), a coding unit (CU), or a coding tree unit (CTU).

Clause 122. The method of clause 121, wherein if there is no MV of the block covering the current sample, a default MV is used.

Clause 123. The method of clause 121, wherein if there is no MV of the block covering the current sample, a replacement MV is used, and wherein the replacement MV is derived from a neighboring block with a MV.

Clause 124. The method of clause 121, wherein if there is a plurality of MVs of the block covering the current sample, one of the plurality of MVs is used.

Clause 125. The method of clause 124, wherein a MV at a center of the block is used.

Clause 126. The method of clause 81, wherein a classification for the plurality of extended taps is performed.

Clause 127. The method of clause 126, wherein the classification for the plurality of extended taps is be performed based on texture information.

Clause 128. The method of clause 126, wherein the classification for extended taps is performed based on band information.

Clause 129. The method of clause 126, wherein a classification for spatial taps is reused for the plurality of extended taps.

Clause 130. The method of clause 126, wherein a class merging for the plurality of extended taps is performed independently.

Clause 131. The method of clause 126, wherein a class merging for spatial taps is reused for the plurality of extended taps.

Clause 132. The method of clause 81, wherein a first syntax element is indicated to indicate whether the plurality of extended taps are enabled.

Clause 133. The method of clause 132, wherein the first syntax element is coded by an arithmetic coding.

Clause 134. The method of clause 133, wherein the first syntax element is coded with at least one context.

Clause 135. The method of clause 134, wherein the context depends on coding information of the current block or a neighboring block.

Clause 136. The method of clause 134, wherein the context depends on a filtering shape of at least one neighboring block.

Clause 137. The method of clause 133, wherein the first syntax element is coded with bypass coding.

Clause 138. The method of clause 132, wherein the first syntax element is binarized by one of: a unary code, a truncated unary code, a fixed-length code, an exponential Golomb code, or a truncated exponential Golomb code.

Clause 139. The method of clause 132, wherein the first syntax element indicated conditionally.

Clause 140. The method of clause 139, wherein the first syntax element is indicated only if the plurality of extended taps are available.

Clause 141. The method of clause 132, wherein the first syntax element is coded in a predictive way.

Clause 142. The method of clause 141, wherein the first syntax element is predicted by an on/off decision of extended taps of at least one neighboring block.

Clause 143. The method of clause 132, wherein the first syntax element is indicated independently for different color components.

Clause 144. The method of clause 143, wherein the first syntax element is indicated and shared for different color components.

Clause 145. The method of clause 143, wherein the first syntax element is indicated for a first color component but not indicated for a second color component.

Clause 146. The method of clause 81, wherein a syntax element structure includes filters with extended taps.

Clause 147. The method of clause 146, wherein coefficients of extended taps are included in the syntax element structure.

Clause 148. The method of clause 146, wherein clipping parameters of extended taps are included in the syntax element structure.

Clause 149. The method of clause 146, wherein class merging results of extended taps are included in the syntax element structure.

Clause 150. The method of clause 146, wherein other parameters of extended taps are included in the syntax element structure.

Clause 151. The method of any of clauses 146-150, wherein the syntax element structure is an adaptation parameter set (APS).

Clause 152. The method of any of clauses 1-151, wherein an indication of whether to and/or how to filter the at least one sample in the current picture based on the information is in the bitstream.

Clause 153. The method of any of clauses 1-151, wherein an indication of whether to and/or how to filter the at least one sample in the current picture based on the information is indicated at one of the followings: a sequence level, a group of pictures level, a picture level, a slice level, or a tile group level.

Clause 154. The method of any of clauses 1-151, wherein an indication of whether to and/or how to filter the at least one sample in the current picture based on the information is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

Clause 155. The method of any of clauses 1-151, wherein an indication of whether to and/or how to filter the at least one sample in the current picture based on the information is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 156. The method of any of clauses 1-151, further comprising: determining, based on coded information of the video unit, whether to and/or how to filter the at least one sample in the current picture based on the information, the coded information including at least one of: a block size, a colour format, a single and/or dual tree partitioning, a colour component, a slice type, or a picture type.

Clause 157. A method of video processing, comprising: determining, during a conversion between a video unit and a bitstream of the video unit, a relaxation of a symmetrical constrain of a parameter in a filtering process; applying the filtering process to the video unit based on the relaxation; and performing the conversion based on the filtered video unit.

Clause 158. The method of clause 157, wherein the parameter comprises at least one of: a coefficient or a clipping parameter.

Clause 159. The method of clause 157, wherein the symmetrical constrain comprises a geometric symmetrical constrain.

Clause 160. The method of clause 157, wherein the parameter comprises: a coefficient and a corresponding clipping parameter, and wherein the coefficient and the corresponding clipping parameter are trained or generated based on an input sample.

Clause 161. The method of clause 157, wherein the relaxation comprises that the symmetrical constrain is totally removed.

Clause 162. The method of clause 161, wherein the relaxation of symmetrical constrain is applied to a diamond with a first size filter shape.

Clause 163. The method of clause 162, wherein a total number of coefficients is increased from a first value to a second value, or wherein a total number of clipping parameters is increased from the first value to the second value.

Clause 164. The method of clause 157, wherein the relaxation comprises that the symmetrical constrain is partially removed.

Clause 165. The method of clause 164, wherein a diamond with a first size filter shape is applied for one filter in the filtering process, and wherein the relaxation of symmetrical constrain is applied to a diamond with a second size area inside the diamond with the first size filter shape, and wherein the second size is smaller than the first size.

Clause 166. The method of clause 165, wherein the number of coefficients is increased from a third value to a fourth value, or wherein the number of clipping parameters is increased from the third value to the fourth value.

Clause 167. The method of clause 164, wherein the relaxation of symmetrical constrain is applied to a square with a third size area inside a filter shape.

Clause 168. The method of clause 167, wherein the number of coefficients is increased from a fifth value to a sixth value, or wherein the number of clipping parameters is increased from the fifth value to the sixth value.

Clause 169. The method of clause 164, wherein the relaxation of symmetrical constrain is applied to an area which is able to be covered by a filter shape of the filtering process.

Clause 170. The method of clause 157, wherein the relaxation of symmetrical constrain is applied to all components.

Clause 171. The method of clause 157, wherein the relaxation of symmetrical constrain is applied to one component.

Clause 172. The method of clause 171, wherein the relaxation of symmetrical constrain is only applied to luma filters in the filtering process.

Clause 173. The method of clause 171, wherein the relaxation of symmetrical constrain is only applied to chroma filters in the filtering process.

Clause 174. The method of clause 157, wherein the relaxation of symmetrical constrain is applied to both of spatial and extended taps inside one ALF filter.

Clause 175. The method of clause 157, wherein the relaxation of symmetrical constrain is only applied to spatial or extended taps inside one ALF filter.

Clause 176. The method of clause 175, wherein the relaxation of symmetrical constrain is only applied to spatial taps inside the ALF filter.

Clause 177. The method of clause 175, wherein the relaxation of symmetrical constrain is only applied to extended taps inside the ALF filter.

Clause 178. The method of clause 157, wherein asymmetrical taps are performed as additional taps.

Clause 179. The method of clause 178, wherein spatial asymmetrical taps are performed as additional taps on top of symmetrical spatial taps.

Clause 180. The method of clause 178, wherein spatial asymmetrical taps are performed as additional taps on top of symmetrical extended taps.

Clause 181. The method of clause 178, wherein extended asymmetrical taps are performed as additional taps on top of symmetrical spatial taps.

Clause 182. The method of clause 178, wherein extended asymmetrical taps are performed as additional taps on top of symmetrical extended taps.

Clause 183. The method of clause 157, wherein there is an on/off control for the relaxation of symmetrical constrain.

Clause 184. The method of clause 183, wherein a flag in APS is used for the on/off control of relaxation of symmetrical constrain.

Clause 185. The method of clause 183, wherein the on/off control is indicated, or wherein the on/off control is inherited, or wherein the on/off control is dynamically derived.

Clause 186. The method of any of clauses 157-185, wherein an indication of whether to and/or how to determine the relaxation of the symmetrical constrain is in the bitstream.

Clause 187. The method of any of clauses 157-185, wherein an indication of whether to and/or how to determine the relaxation of the symmetrical constrain is indicated at one of the followings: a sequence level, a group of pictures level, a picture level, a slice level, or a tile group level.

Clause 188. The method of any of clauses 157-185, wherein an indication of whether to and/or how to determine the relaxation of the symmetrical constrain is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

Clause 189. The method of any of clauses 157-185, wherein an indication of whether to and/or how to determine the relaxation of the symmetrical constrain is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 190. The method of any of clauses 157-185, further comprising: determining, based on coded information of the video unit, whether to and/or how to determine the relaxation of the symmetrical constrain, the coded information including at least one of: a block size, a colour format, a single and/or dual tree partitioning, a colour component, a slice type, or a picture type.

Clause 191. The method of any of clauses 1-190, wherein during the filtering process, at least one of: filtering at least one sample based on the information or the relaxation of the symmetrical constrain is applied.

Clause 192. The method of any of clauses 1-191, wherein a filter shape selection method is applied to the filtering process is one of the followings in video coding: an in-loop filtering method, a pre-processing filtering method, or a post-processing filtering method.

Clause 193. The method of clause 192, wherein the in-loop filtering method comprises at least one of: an ALF, a cross-component ALF, or another in-loop filter method.

Clause 194. The method of any of clauses 1-193, wherein the conversion includes encoding the video unit into the bitstream.

Clause 195. The method of any of clauses 1-193, wherein the conversion includes decoding the video unit from the bitstream.

Clause 196. The method of any of clauses 1-151, wherein the video unit comprises one of: a sequence, a picture, a sub-picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), or a region that contains more than one luma or chroma sample or pixel.

Clause 197. An apparatus for processing video data comprising a processor and a non-transitory memory with instructions thereon, wherein the instructions upon execution by the processor, cause the processor to perform a method in accordance with any of clauses 1-196.

Clause 198. A non-transitory computer-readable storage medium storing instructions that cause a processor to perform a method in accordance with any of clauses 1-196.

Clause 199. A non-transitory computer-readable recording medium storing a bitstream of a video which is generated by a method performed by a video processing apparatus, wherein the method comprises: determining information of a previously coded picture associated with a video unit of the video; during a filtering process, filtering at least one sample of the video unit based on the information; and generating a bitstream of the target block based on the filtered at least one sample.

Clause 200. A method for storing bitstream of a video, comprising: determining information of a previously coded picture associated with a video unit of a current picture of the video; during a filtering process, filtering at least one sample of the video unit based on the information; generating a bitstream of the target block based on the filtered at least one sample; and storing the bitstream in a non-transitory computer-readable recording medium.

Clause 201. A non-transitory computer-readable recording medium storing a bitstream of a video which is generated by a method performed by a video processing apparatus, wherein the method comprises: determining a relaxation of a symmetrical constrain of a parameter in a filtering process; applying the filtering process to a video unit of the video based on the relaxation; and generating a bitstream of the target block based on the filtered video unit.

Clause 202. A method for storing bitstream of a video, comprising: determining a relaxation of a symmetrical constrain of a parameter in a filtering process; applying the filtering process to a video unit of the video based on the relaxation; generating a bitstream of the target block based on the filtered video unit; and storing the bitstream in a non-transitory computer-readable recording medium.

### Example Device

FIG. 23 illustrates a block diagram of a computing device 2300 in which various embodiments of the present disclosure can be implemented. The computing device 2300 may be implemented as or included in the source device 110 (or the video encoder 114 or 200) or the destination device 120 (or the video decoder 124 or 300).

It would be appreciated that the computing device 2300 shown in FIG. 23 is merely for purpose of illustration, without suggesting any limitation to the functions and scopes of the embodiments of the present disclosure in any manner.

As shown in FIG. 23, the computing device 2300 includes a general-purpose computing device 2300. The computing device 2300 may at least comprise one or more processors or processing units 2310, a memory 2320, a storage unit 2330, one or more communication units 2340, one or more input devices 2350, and one or more output devices 2360.

In some embodiments, the computing device 2300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2300 can support any type of interface to a user (such as “wearable” circuitry and the like).

The processing unit 2310 may be a physical or virtual processor and can implement various processes based on programs stored in the memory 2320. In a multi-processor system, multiple processing units execute computer executable instructions in parallel so as to improve the parallel processing capability of the computing device 2300. The processing unit 2310 may also be referred to as a central processing unit (CPU), a microprocessor, a controller or a microcontroller.

The computing device 2300 typically includes various computer storage medium. Such medium can be any medium accessible by the computing device 2300, including, but not limited to, volatile and non-volatile medium, or detachable and non-detachable medium. The memory 2320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2330 may be any detachable or non-detachable medium and may include a machine-readable medium such as a memory, flash memory drive, magnetic disk or another other media, which can be used for storing information and/or data and can be accessed in the computing device 2300.

The computing device 2300 may further include additional detachable/non-detachable, volatile/non-volatile memory medium. Although not shown in FIG. 23, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2340 communicates with a further computing device via the communication medium. In addition, the functions of the components in the computing device 2300 can be implemented by a single computing cluster or multiple computing machines that can communicate via communication connections. Therefore, the computing device 2300 can operate in a networked environment using a logical connection with one or more other servers, networked personal computers (PCs) or further general network nodes.

The input device 2350 may be one or more of a variety of input devices, such as a mouse, keyboard, tracking ball, voice-input device, and the like. The output device 2360 may be one or more of a variety of output devices, such as a display, loudspeaker, printer, and the like. By means of the communication unit 2340, the computing device 2300 can further communicate with one or more external devices (not shown) such as the storage devices and display device, with one or more devices enabling the user to interact with the computing device 2300, or any devices (such as a network card, a modem and the like) enabling the computing device 2300 to communicate with one or more other computing devices, if required. Such communication can be performed via input/output (I/O) interfaces (not shown).

In some embodiments, instead of being integrated in a single device, some or all components of the computing device 2300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2300 may be used to implement video encoding/decoding in embodiments of the present disclosure. The memory 2320 may include one or more video coding modules 2325 having one or more program instructions. These modules are accessible and executable by the processing unit 2310 to perform the functionalities of the various embodiments described herein.

In the example embodiments of performing video encoding, the input device 2350 may receive video data as an input 2370 to be encoded. The video data may be processed, for example, by the video coding module 2325, to generate an encoded bitstream. The encoded bitstream may be provided via the output device 2360 as an output 2380.

In the example embodiments of performing video decoding, the input device 2350 may receive an encoded bitstream as the input 2370. The encoded bitstream may be processed, for example, by the video coding module 2325, to generate decoded video data. The decoded video data may be provided via the output device 2360 as the output 2380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, during a conversion between a video unit of a current picture of a video and a bitstream of the video unit, information of a previously coded picture associated with the video unit;
during a filtering process, filtering at least one sample of the video unit based on the information; and
performing the conversion based on the filtered at least one sample.

2. The method of claim 1, wherein a plurality of extended taps for adaptive loop filter (ALF) are used based on one or more previously coded pictures.

3. The method of claim 1, wherein the previously coded picture is one of:
a reference picture in a reference picture list (RPL), and wherein the RPL is associated with one of: a current block, a current slice, or the current picture; or
a reference picture in a reference picture set (PRS), and wherein the PRS is associated with one of: the current block, the current slice, or the current picture.

4. The method of claim 1, wherein a plurality of extended taps obtains information from one or more previously coded pictures in list 0, or
wherein the plurality of extended taps obtains information from one or more previously coded pictures in list 1, or
wherein a plurality of extended taps obtains information from a reference picture with a reference index equal to a value in a reference list.

5. The method of claim 1, wherein whether to determine the information from the previously coded picture is dependent on a slice type or a picture type.

6. The method of claim 1, wherein the extended plurality of taps obtains motion information of a current block and reconstructed samples in the previously coded picture to generate a reference block, and wherein the reference block is derived by reusing a motion vector included in the current block.

7. The method of claim 1, wherein a plurality of extended taps obtain information of Luma component in a current picture or a current slice to filter Chroma samples, and/or
wherein the plurality of extended taps obtain information of Luma component in the previously coded picture or slice to filter Chroma samples, and/or
wherein the plurality of extended taps obtain information of a first chroma component in a current picture or slice to filter Chroma samples of a second chroma component.

8. The method of claim 1, wherein the plurality of extended taps are applied to both of Luma and Chroma components, or
wherein the plurality of extended taps are only applied to Luma component, or
wherein the plurality of extended taps are only applied to Chroma component.

9. The method of claim 1, wherein the plurality of extended taps are combined with spatial taps to form a filter.

10. The method of claim 1, wherein coefficients of a plurality of extended and spatial taps are trained jointly, and/or
wherein clipping parameters of a plurality extended and spatial taps are generated jointly.

11. The method of claim 1, wherein the plurality of extended taps use one of:
a diamond shape,
a square shape,
a cross shape,
a symmetrical shape,
an asymmetrical shape,
another shape.

12. The method of claim 1, wherein the plurality of extended taps uses a filter length equal to a value.

13. The method of claim 1, wherein a geometric symmetrical constrain is performed on the plurality of extended taps.

14. The method of claim 1, wherein a center of a filtering shape of extended taps is at a same position of a current sample to be filtered but is in different pictures, and/or
wherein a classification for spatial taps is reused for the plurality of extended taps.

15. The method of claim 1, wherein a first syntax element indicating whether the plurality of extended taps is binarized by one of:
a unary code,
a truncated unary code,
a fixed-length code,
an exponential Golomb code, or
a truncated exponential Golomb code.

16. The method of claim 1, wherein coefficients of extended taps are included in a syntax element structure, and/or
wherein clipping parameters of extended taps are included in the syntax element structure.

17. The method of claim 1, wherein the conversion includes encoding the video unit into the bitstream, or
wherein the conversion includes decoding the video unit from the bitstream.

18. An apparatus for processing video data comprising a processor and a non-transitory memory with instructions thereon, wherein the instructions upon execution by the processor, cause the processor to:
determine, during a conversion between a video unit of a current picture of a video and a bitstream of the video unit, information of a previously coded picture associated with the video unit;
during a filtering process, filter at least one sample of the video unit based on the information; and
perform the conversion based on the filtered at least one sample.

19. A non-transitory computer-readable storage medium storing instructions that cause a processor to:
determine, during a conversion between a video unit of a current picture of a video and a bitstream of the video unit, information of a previously coded picture associated with the video unit;
during a filtering process, filter at least one sample of the video unit based on the information; and
perform the conversion based on the filtered at least one sample.

20. A non-transitory computer-readable recording medium storing a bitstream of a video which is generated by a method performed by a video processing apparatus, wherein the method comprises:
determining information of a previously coded picture associated with a video unit of a current picture of the video;
during a filtering process, filtering at least one sample of the video unit based on the information; and
generating a bitstream of the target block based on the filtered at least one sample.
